(19) United States
(12) Patent Application Publication
(10) Pub. No.: US 2024/0171868 A1
(43) Pub. Date: May 23, 2024

(54) IMAGING ELEMENT, IMAGING DEVICE AND ELECTRONIC DEVICE

(71) Applicant: Sony Semiconductor Solutions Corporation, Kanagawa (JP)

(72) Inventor: Masashi Nakata, Kanagawa (JP)

(21) Appl. No.: 18/551,087

(22) PCT Filed: Mar. 2, 2022
(86) PCT No.: PCT/JP2022/008716

§ 371 Date: Sep. 18, 2023

(30) Foreign Application Priority Data
May 11, 2021 (JP) 2021-080601

(51) Int. Cl. H04N 23/84; G06V 10/143; G06V 10/56; G06V 10/74

(52) U.S. Cl. CPC H04N 23/84; G06V 10/143; G06V 10/56; G06V 10/761

(57) ABSTRACT

[Problem] To improve the color performance of an imaging element.

[Solution] An imaging element includes pixels that receive light corresponding to three primary colors, and divided pixels that form light receiving units in the pixels. The divided pixels include: a divided pixel configured to receive light of a first color in the pixel that receives the light of the first color among the three primary colors; a divided pixel configured to receive light of a second color in the pixel that receives the light of the second color among the three primary colors; a divided pixel configured to receive light of a third color in the pixel that receives the light of the third color among the three primary colors; and a divided pixel configured to receive light of a fourth color different from any of the three primary colors in the pixel that receives the light of any of the three primary colors. A spectrum of the light of the fourth color has a maximum value in a region in which absolute values of negative values in color-matching functions of the first color, the second color, and the third color are larger than in other regions.

### TECHNICAL FIELD

The present disclosure relates to an imaging element, an imaging device, and an electronic device.

### BACKGROUND ART

Image sensors that perform imaging in three primary colors of RGB are often used, but it is known that faithful color reproduction is difficult with only RGB information. One of the reasons for this is that the color-matching function representation has a large negative component at wavelengths around 520 nm. A pixel having a peak in this wavelength region is required to generate this negative component in matrix arithmetic processing using a linear matrix.

In order to cope with this, there is an imaging element having an RGBE arrangement in which an emerald (E) element is added to RGB. However, in such an arrangement, G pixels, which have a high contribution rate to the luminance signal, are reduced, and there are problems in terms of both SNR (Signal to Noise Ratio) and color reproduction. Thus, such an imaging element has not yet become widespread.

### CITATION LIST

### Patent Literature

### PTL 1

JP 2004-200357A

### SUMMARY

### Technical Problem

Therefore, the present disclosure provides an imaging element that realizes imaging with high color reproducibility.

### Solution to Problem

According to one embodiment, an imaging element includes pixels configured to receive light corresponding to three primary colors; and divided pixels configured to form light-receiving units in the pixels. The divided pixels include: a divided pixel configured to receive light of a first color in the pixel that receives the light of the first color among the three primary colors; a divided pixel configured to receive light of a second color in the pixel that receives the light of the second color among the three primary colors; a divided pixel configured to receive light of a third color in the pixel that receives the light of the third color among the three primary colors; and a divided pixel configured to receive light of a fourth color different from any of the three primary colors in the pixel that receives the light of any of the three primary colors. A spectrum of the light of the fourth color has a maximum value in a region in which absolute values of negative values in color-matching functions of the first color, the second color, and the third color are larger than in other regions.

2×2 or more divided pixels may be provided in the pixel.

The three primary colors may be RGB (Red, Green, Blue), a color-matching function of the fourth color may have a maximum value in a wavelength range of 520 nm±10 nm, and the number of divided pixels that receive the light of the fourth color may be smaller than the number of divided pixels that receive the G light.

The fourth color may be emerald, and the divided pixel that receives the light of the fourth color may be at least one divided pixel among the divided pixels included in the pixel that receives the R light.

The divided pixels that receive emerald light may be provided, with a number thereof being in a proportion equal to or less than that of the divided pixels that receive the R light.

at least 2×2 divided pixels may be provided in the pixel that receives the R light, and the divided pixel that receives emerald light may be one of the divided pixels in the pixel that receives the R light.

at least 2×2 divided pixels may be provided in the pixel that receives the R light, and the divided pixels that receive emerald light may be provided in a diagonal direction, among the divided pixels in the pixel that receive the R light.

3×2 or more divided pixels may be provided in the pixel that receives the R light, and a center of gravity of the divided pixels that receive the R light may be aligned with a center of gravity of the divided pixels that receive the emerald light.

An output from the divided pixel that receives the R light may be corrected using an output from the divided pixel that receives the emerald light.

The imaging element may further include an analog-to-digital conversion circuit configured to acquire an analog signal output from the divided pixel and convert the analog signal into a digital signal, and in the analog digital conversion circuit, the R light signal and the emerald light signal may be counted in opposite directions.

The fourth color may be emerald, and the divided pixel that receives the light of the fourth color may be at least one divided pixel among the divided pixels included in the pixel that receives the B light.

An output from the divided pixel that receives the B light may be corrected using an output from the divided pixel that receives the emerald light.

The pixel may include an on-chip lens, and the on-chip lenses provided in the pixel including the divided pixel that receives the light of the fourth color may have a shape different from those of the on-chip lenses provided in the other pixels.

The pixel may include an on-chip lens, and the on-chip lens provided in the pixel including the divided pixels that receive the R and emerald light may have a shape different from those of the on-chip lenses provided in the divided pixels that receive the G and B light.

The pixel may include an on-chip lens, and the on-chip lens may be provided so as to cover all the divided pixels in the pixel including the divided pixels that receive the R and emerald light and are arranged in a vertically and horizontally symmetrical arrangement.

The pixel may include an on-chip lens, and the on-chip lens provided in the pixel including the divided pixels that receive the B and emerald light may have a shape different from that of the on-chip lenses provided in the divided pixels that receive the G and R light.

The pixel may include an on-chip lens, and the on-chip lens may be provided so as to cover all the divided pixels in the pixel including the divided pixels that receive the B and emerald light and are arranged in a vertically and horizontally symmetrical arrangement.

According to one embodiment, an imaging device includes any of the imaging elements described above.

According to one embodiment, an electronic device includes any of the imaging elements described above, and a display having a display surface on a light-receiving surface side of the imaging element, and having the imaging device embedded therein.

According to one embodiment, an electronic device includes pixels configured to receive light corresponding to three primary colors of RGB; 2×2 or more divided pixels configured to form light-receiving units in the pixels; and a display having a display surface on a light-receiving surface side of the pixels, and having the pixels embedded therein, wherein the divided pixels include: a divided pixel configured to receive light of a first color in the pixel that receives the light of the first color among the three primary colors; a divided pixel configured to receive light of a second color in the pixel that receives the light of the second color among the three primary colors; a divided pixel configured to receive light of a third color in the pixel that receives the light of the third color among the three primary colors; and a divided pixel configured to receive light of an emerald color different from any of the three primary colors in the pixel that receives the light of any one of the three primary colors, and a spectrum of the light of the emerald color has a maximum value in a wavelength range of 520 nm±10 nm, and the number of divided pixels that receive the emerald light is smaller than the number of divided pixels that receive the G light.

The display may be made of a material that includes a material that absorbs light in a wavelength region of 450 nm or less.

The display may be made of a material containing polyimide.

An output from the divided pixel that receives the R light may be corrected based on an output from the divided pixel that receives the emerald light.

An output from the divided pixel that receives the B light may be corrected based on an output from the divided pixel that receives the emerald light.

The electronic device may further include: an analog-to-digital conversion circuit configured to convert an analog signal output from the divided pixels into a digital signal; and a signal processing circuit configured to perform signal processing on an output of the analog-to-digital conversion circuit, and the signal processing circuit may improve light sensing accuracy, based on the digital signal.

The signal processing circuit may improve color reproducibility.

The signal processing circuit may perform light source estimation.

The electronic device may be an imaging device.

The electronic device may be a medical device.

The electronic device may be a smartphone.

According to one embodiment, an imaging element includes pixels; and pixel groups in which the pixels for receiving light corresponding to three primary colors are arranged in a predetermined arrangement, wherein the pixels include: a pixel configured to receive light of a first color in the pixel group that receives the light of the first color among the three primary colors; a pixel configured to receive the light of a second color in the pixel group that receives the light of the second color among the three primary colors; a pixel configured to receive the light of a third color in the pixel group that receives the light of the third color among the three primary colors; and a pixel configured to receive light of a fourth color different from any of the three primary colors in the pixel group that receives the light of any one of the three primary colors, and a spectrum of the light of the fourth color has a maximum value in a region in which absolute values of negative values in color-matching functions of the first color, the second color, and the third color are larger than in other regions.

The pixel may form a pixel pair with an adjacent pixel, and the imaging element may further include an on-chip lens formed for the pixel pair.

The three primary colors may be RGB (Red, Green, Blue), a color-matching function of the fourth color may have a maximum value in a wavelength range of 520 nm±10 nm, and the number of pixels for receiving the light of the fourth color may be smaller than the number of pixels for receiving the G light.

The fourth color may be emerald, and the pixel that receives the light of the fourth color may be included in the pixel group that receives the R light.

In the pixel group that receives the R light, a center of gravity of the pixels that receive the R light may be aligned with a center of gravity of the pixels that receive the emerald light.

The fourth color may be emerald, and the pixel that receives the fourth color light may be included in the pixel group that receives the B light.

According to one embodiment, an imaging element includes the imaging element described above.

According to one embodiment, an electronic device includes the imaging element described above.

The imaging element may be formed of a laminated semiconductor.

This semiconductor may be laminated in a form of CoC.

This semiconductor may be laminated in a form of CoW.

This semiconductor may be laminated in a form of WoW.

### BRIEF DESCRIPTION OF DRAWINGS

FIG. 1 is an external view schematically showing an electronic device according to an embodiment.

FIG. 2 is a diagram schematically showing a pixel array according to one embodiment.

FIG. 3 is a diagram schematically showing pixels according to one embodiment.

FIG. 4 is a graph showing RGB color-matching functions.

FIG. 5 is a diagram schematically showing pixels according to one embodiment.

FIG. 6 is a diagram schematically showing pixels according to one embodiment.

FIG. 7 is a diagram schematically showing pixels according to one embodiment.

FIG. 8 is a diagram schematically showing pixels according to one embodiment.

FIG. 9 is a diagram schematically showing pixels according to one embodiment.

FIG. 10 is a diagram schematically showing pixels according to one embodiment.

FIG. 11 is a diagram schematically showing pixels according to one embodiment.

FIG. 12 is a diagram schematically showing pixels according to one embodiment.

FIG. 13 is a diagram schematically showing pixels according to one embodiment.

FIG. 14 is a diagram schematically showing pixels according to one embodiment.

FIG. 15 is a diagram schematically showing pixels according to one embodiment.

FIG. 16 is a diagram schematically showing pixels according to one embodiment.

FIG. 17 is a diagram schematically showing pixels according to one embodiment.

FIG. 18 is a diagram schematically showing pixels according to one embodiment.

FIG. 19 is a diagram schematically showing pixels according to one embodiment.

FIG. 20 is a block diagram showing the configuration of an imaging element according to one embodiment.

FIG. 21 is a diagram showing processing in an imaging element according to one embodiment.

FIG. 22 is a diagram showing AD conversion according to one embodiment.

FIG. 23 is a diagram showing an implementation example of an imaging element according to one embodiment.

FIG. 24 is a diagram showing an implementation example of an imaging element according to one embodiment.

FIG. 25 is a diagram showing an implementation example of an imaging element according to one embodiment.

FIG. 26 is a diagram schematically showing pixels according to one embodiment.

FIG. 27 is a graph showing an example of correction according to one embodiment.

FIG. 28 is a diagram schematically showing pixels according to one embodiment.

FIG. 29A is a diagram schematically showing pixels according to one embodiment.

FIG. 29B is a diagram schematically showing pixels according to one embodiment.

FIG. 29C is a diagram schematically showing pixels according to one embodiment.

FIG. 30 is a diagram schematically showing pixels according to one embodiment.

FIG. 31 is a diagram schematically showing pixels according to one embodiment.

FIG. 32 is a diagram schematically showing pixels according to one embodiment.

FIG. 33 is a diagram schematically showing pixels according to one embodiment.

FIG. 34A is a view showing the interior of a vehicle from the rear to the front of the vehicle.

FIG. 34B is a view showing the interior of a vehicle from the oblique rear to the oblique front of the vehicle.

FIG. 35A is a front view of a digital camera, which is a second application example of the electronic device.

FIG. 35B is a rear view of the digital camera.

FIG. 36A is an external view of an HMD, which is a third application example of the electronic device.

FIG. 36B is an external view of smart glasses.

FIG. 37 is an external view of a TV, which is a fourth application example of the electronic device.

FIG. 38 is an external view of a smartphone, which is a fifth application example of the electronic device.

### DESCRIPTION OF EMBODIMENTS

Hereinafter, embodiments of the present disclosure will be described with reference to the drawings. The drawings are used for explanation, and it is not necessary that the shapes, sizes, ratios, and the like of the configuration of each part in the actual apparatus are as shown in the drawings. In addition, since the drawings are drawn in a simplified manner, it is assumed that configurations necessary for implementation other than those shown in the drawings are appropriately provided.

### First Embodiment

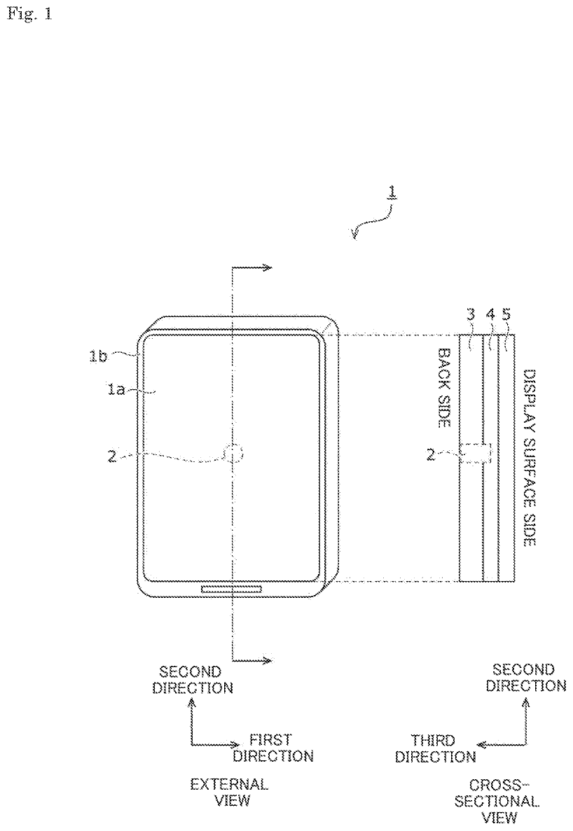

FIG. 1 is an external view and a cross-sectional view schematically showing an electronic device according to an embodiment. The electronic device 1 is any electronic device having both a display function and a photographing function, such as a smartphone, a mobile phone, a tablet terminal, or a PC. The electronic device 1 is not limited to these examples, and may be other devices such as imaging devices such as cameras, medical devices, and inspection devices. As shown in the figure, a first direction, a second direction and a third direction are defined for convenience. The electronic device 1 includes an imaging element 2, a component layer 3, a display 4, and a cover glass 5.

The electronic device 1 includes, for example, a display region 1a and a bezel 1b as shown in the external view. The electronic device 1 displays images, videos, and the like on the display region 1a. The bezel 1b is sometimes provided with a front-facing camera to acquire an image on the display surface side, but today, it is often required to narrow the region occupied by the bezel 1b. For this reason, the electronic device 1 according to the present embodiment includes the imaging element 2 below the display, and narrows the region occupied by the bezel 1b on the display surface side.

The imaging element 2 includes a light-receiving element and a signal processing circuit that performs signal processing on signals output from the light-receiving element. The imaging element 2 acquires information on an image based on the light received by the light-receiving element. The imaging element 2 may be implemented, for example, by a semiconductor formed from multiple layers. Details of the imaging element 2 will be described later. Although the imaging element 2 is circular in the drawing, it is not limited to this and may be of any shape such as a rectangle.

The component layer 3 is a layer to which the imaging element 2 belongs. The component layer 3 includes, for example, various modules and devices for realizing processing other than imaging in the electronic device 1.

The display 4 is a display for outputting images, videos, and the like. As shown in the cross-sectional view, the display 4 has the imaging element 2 and the component layer 3 on the back side thereof. Further, the imaging element 2 is provided so as to be embedded in the display 4 as shown in the figure.

This display 4 may be made of a material that includes a material that absorbs light in the wavelength region of 450 nm or less, for example, due to its properties. A material that absorbs light in the wavelength region of 450 nm or less is, for example, polyimide. Polyimide is a material that absorbs light in the wavelength region of 450 nm or less, that is, in the blue wavelength region.

Thus, if the imaging element 2 is embedded in the display 4, the possibility that the imaging element 2 will be difficult to receive light in the blue wavelength region increases. Therefore, it is desirable to appropriately improve the intensity of blue light in the imaging element 2.

The cover glass 5 is a glass layer that protects the display 4. A polarizing layer may be provided between the display 4 and the cover glass 5 so that the light output from the display 4 can be appropriately viewed by the user, and layers of arbitrary types (pressure-sensitive, electrostatic, and the like) may be provided so that the display region 1a can be used as a touch panel. In addition to these, arbitrary layers may be provided between the display 4 and the cover glass 5 in such a form that the imaging element 2 performs a photographing operation appropriately and the display 4 performs displaying operation appropriately.

In the following description, specific implementation of light-receiving elements, lenses, circuits, and the like in semiconductor layers and the like is not described because it is not an essential configuration of the present disclosure. These components can be implemented using an arbitrary method in the shape, configuration, and the like that can be read from the drawings, description, and the like. For example, control of the imaging element, acquisition of signals, and the like can be realized by an arbitrary method unless otherwise specified.

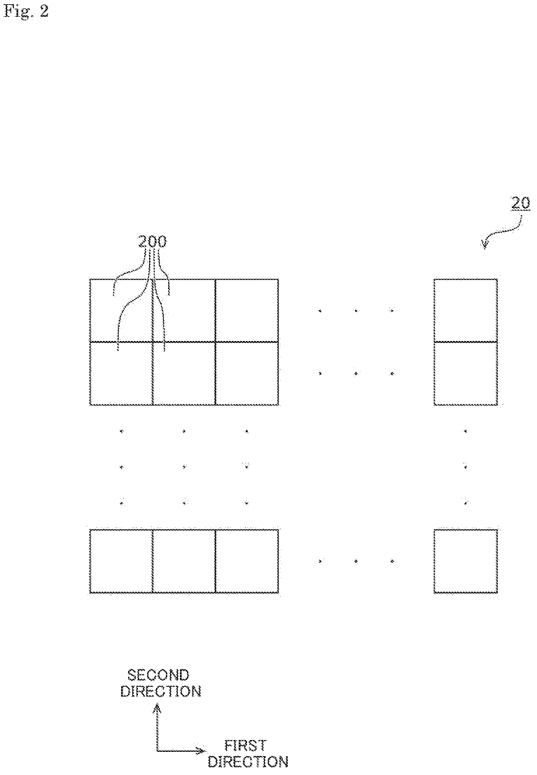

FIG. 2 is a diagram showing a pixel array provided in the imaging element 2. The imaging element 2 has a pixel array 20 as a light-receiving region. The pixel array 20 includes a plurality of pixels 200. The pixels 200 are arranged in an array along the first direction and the second direction, for example. Note that the directions are given as an example, and are not limited to the first direction and the second direction. For example, the direction may be shifted by 45 degrees, or the direction may be shifted by any other angle.

The pixels 200 are light-receiving pixels, and each pixel 200 may be configured to receive light of a predetermined color. The color of the light obtained by the pixels 200 may be represented by, for example, the three primary colors of R (red), G (green), and B (blue). In the present embodiment, a region is provided in the pixel that receives light of emerald color, as the fourth color, that transmits a spectrum different from any of the three primary colors of RGB.

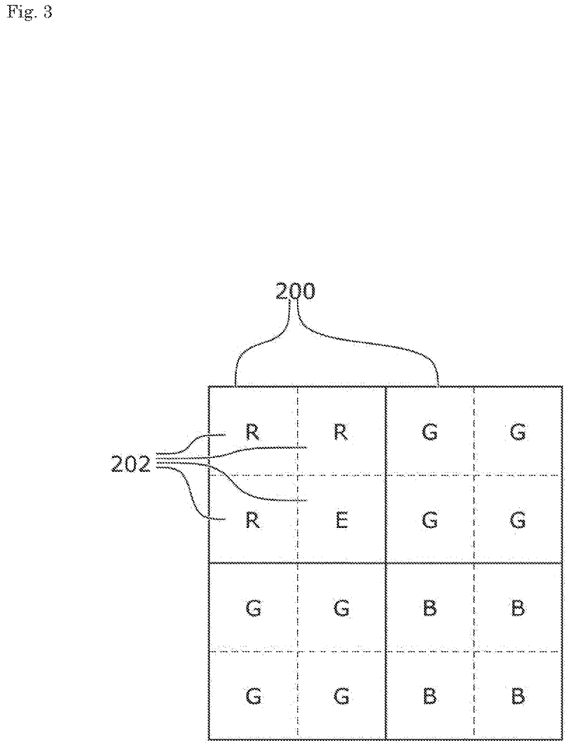

FIG. 3 is a diagram in which a portion of the pixels 200 is extracted. Each pixel 200 has a plurality of divided pixels 202. For example, as shown in FIG. 3, the pixel 200 has 2×2 divided pixels 202. Solid lines represent boundaries of pixels 200 and dotted lines represent boundaries of divided pixels 202.

In the present disclosure, a divided pixel 202 indicates, for example, a region obtained by dividing a light-receiving element in the pixel 200 which is the unit of imaging. The pixel 200 has a pixel circuit for each pixel 200, and the imaging element 2 acquires information for each pixel based on the output of this pixel circuit. The divided pixels 202 belonging to the same pixel 200 output a signal through the pixel circuit corresponding to the pixel 200. For example, the divided pixels 202 belonging to the same pixel 200 share transistors forming floating diffusions and other switches, capacitors for storing electricity, and the like, and output analog signals to other circuits. In this way, the divided pixels 202 are units that do not have independent pixel circuits, but are controlled by the pixel circuit provided for each pixel 200, and can appropriately perform individual outputs. In other words, the divided pixels 202 are not simply a set of small pixels 200, but a unit indicated by a region obtained by dividing the light-receiving region of the pixel 200.

The pixel 200 is configured with a light-receiving element that receives light of three primary colors, as described above. For example, the pixel 200 includes a pixel that receives the R light, a pixel that receives the G light, and a pixel that receives the B light. For example, the color of the light received by the pixel 200 is set by forming a color filter for each pixel 200 or each divided pixel 202, or by forming an organic photoelectric conversion film for each color.

As shown in FIG. 3, as an example of the present embodiment, a pixel 200 that receives the R light includes a divided pixel 202 that receives the R light and a divided pixel 202 that receives emerald (hereinafter sometimes referred to as E) light. Further, as an example, the pixel 200 that receives the G light may be composed of the divided pixels 202 that receive the G light, and the pixel 200 that receives the B light may be composed of the divided pixels 202 that receive the B light.

The pixels 200 that receive R, G, and B light are arranged in, for example, a Bayer arrangement. It is not limited to this, and other arrangements may be used. Regardless of the arrangement, it is desirable that the divided pixels 202 that receive the E light are provided in a smaller proportion than the divided pixels 202 that receive the G light. This is because G light has a great influence on brightness information, and it is not desirable to reduce brightness information in a captured image or the like.

Further, similarly to the divided pixels 202 that receive the G light, it is desirable that the divided pixels 202 that receive the E light are included in a smaller proportion than the divided pixels 202 that receive the B light and in a proportion equal to or less than the divided pixels 202 that receive the R light.

The divided pixel 202 that receives the E light is, for example, one of the divided pixels 202 belonging to the pixel 200 that receives the R light, and is arranged as shown in the drawing.

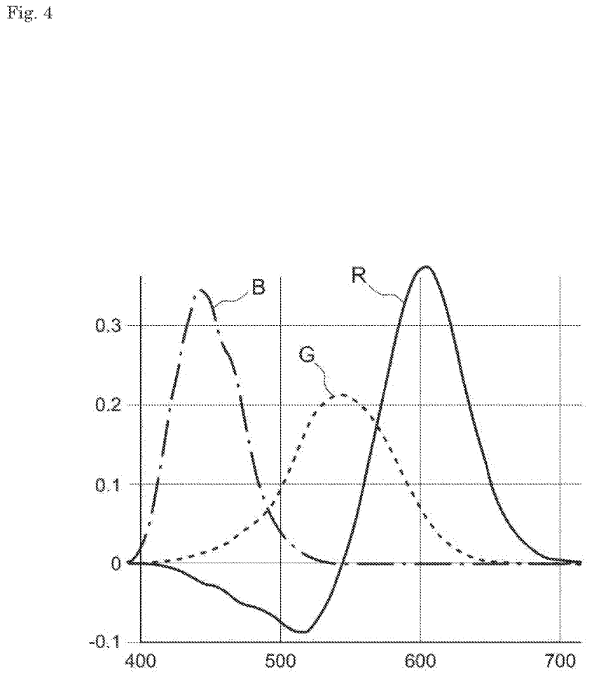

FIG. 4 is a graph showing RGB color-matching functions. As shown in this graph, when the three primary colors of RGB are represented by the color-matching function, the R color-matching function has a large negative value in the wavelength region of 520 nm. When such a filter is used, color reproducibility may deteriorate in this wavelength region.

On the other hand, emerald has a spectrum with a maximum value (peak) at 520 nm±10 nm. Therefore, by correcting the signal output from the divided pixel 202 that receives the R light with the signal output from the divided pixel 202 that receives the E light, the signal in the negative-value region of the R color-matching function can be reinforced. For this reason, as shown in FIG. 3, it is desirable that part of the divided pixels 202 belonging to the pixel 200 that receives the R light is the divided pixel 202 that receives the E light. Therefore, it is not limited to emerald, and the divided pixels 202 may receive light of other colors having a spectrum with a peak in this region.

By providing the divided pixel 202 that receives the E light in the pixel 200 that receives the R light, the light in the same or near region as the divided pixel 202 that receives the R light can be received as a signal of a different color. Therefore, by providing the divided pixel 202 for receiving the E light in this way, it is possible to reduce the misalignment of the light-receiving position when the E signal is used to correct the R signal, thereby improving the color reproducibility.

For example, if the pixel itself receives the E light, misalignment occurs between the pixel receiving the R light and the pixel receiving the E light, and this misalignment needs to be taken into account when performing correction, or correction accuracy will be low. Therefore, depending on the processing, false colors often occur. On the other hand, as in the present embodiment, by providing the divided pixel 202 for receiving the E light in the pixel 200 for receiving the R light, the influence of the correction error due to misalignment such as false colors can be suppressed.

Further, by providing the divided pixel 202 for receiving the E light in the pixel 200 for receiving the R light, the floating diffusion can be shared with the divided pixel 202 for receiving the R light in the pixel circuit. Therefore, it is possible to correct the R signal at the timing of outputting a digital signal in an analog-to-digital conversion circuit (hereinafter referred to as ADC: Analog to Digital Converter).

For example, in the counter circuit of the ADC, the output from the divided pixel 202 that receives the E light is counted on the negative side, and the output from the divided pixel 202 that receives the R light is added to this negative value. In this way, the output of the ADC in which the R signal is corrected can be obtained. This processing may be reversed, and the R signal may be added and then, the E signal may be subtracted.

As another example, when CDS (Correlated Double Sampling) is executed in the ADC, the signal from the divided pixel 202 that receives the E light in the P phase may be counted on the negative side, and the signal from the divided pixel 202 that receives the R light in the D phase may be output.

In this way, by providing the divided pixel 202 that receives the E light in the pixel 200 that receives the R light, it is possible to improve the efficiency and accuracy of signal processing.

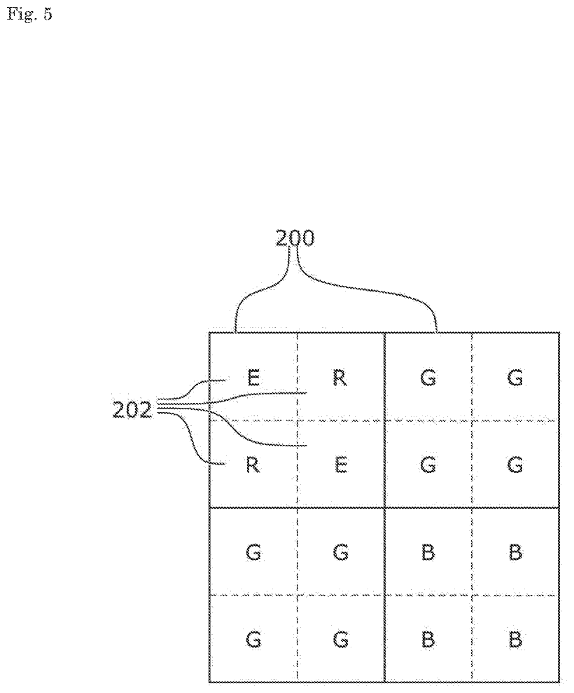

FIG. 5 is a diagram showing another example of arrangement of the divided pixels 202. In this way, in the pixel 200 that receives the R light, the divided pixels 202 that receive the E light may be provided as diagonal components.

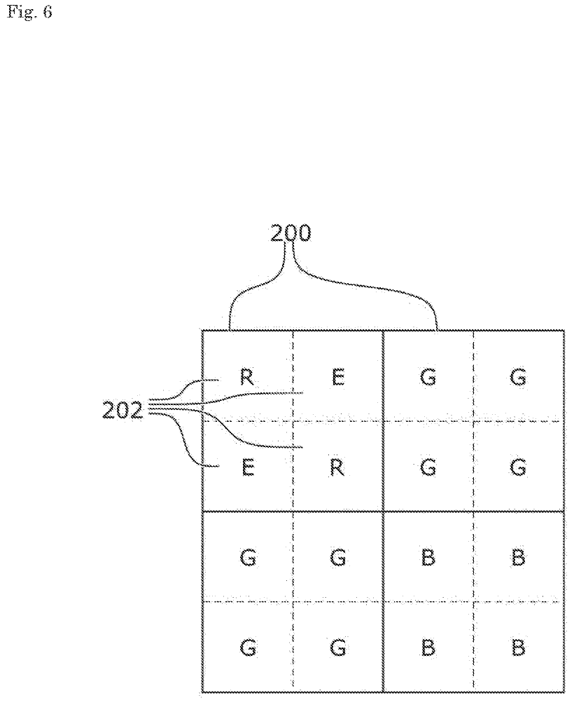

FIG. 6 is a diagram showing another example of arrangement of the divided pixels 202. In this way, in the pixel 200 that receives the R light, the divided pixels 202 that receive the E light may be provided as diagonal components in the direction opposite to that in FIG. 5.

When the pixel 200 is provided with 2×2 divided pixels 202, by providing the divided pixels 202 for receiving the E light diagonally, the center of gravity of the divided pixel 202 for receiving the R light and the center of gravity of the divided pixel 202 for receiving the E light can be aligned in the pixel 200 for receiving the R light. With this arrangement, it is possible to further suppress the influence of misalignment, such as the occurrence of false colors as described above. Even in these arrangements, the proportion of the divided pixels 202 that receive the R light can be maintained at the same value as the proportion of the divided pixels 202 that receive the E light.

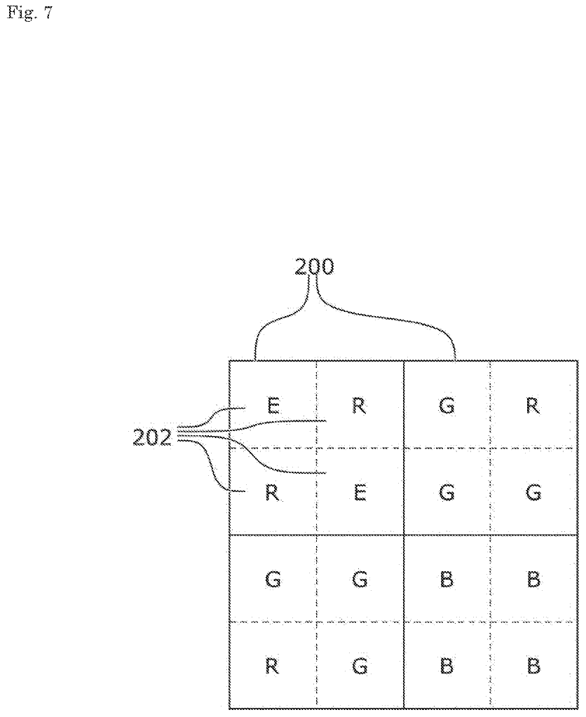

FIG. 7 is a diagram showing still another example. As shown in this figure, in order to reinforce the R signal, the divided pixel 202 that receives the R light reduced due to the divided pixel 202 that receives the E light may be provided in the pixel 200 that receives the G light.

The pixel 200 may not be divided into 2×2 unlike FIGS. 3 and 5 to 7. More divisions may be made. Even when the number of divided pixels 202 larger than 2×2 is provided in the pixel 200, it is desirable that the center of gravity of the divided pixel 202 that receives the R light is aligned with the center of gravity of the divided pixel 202 that receives the E light.

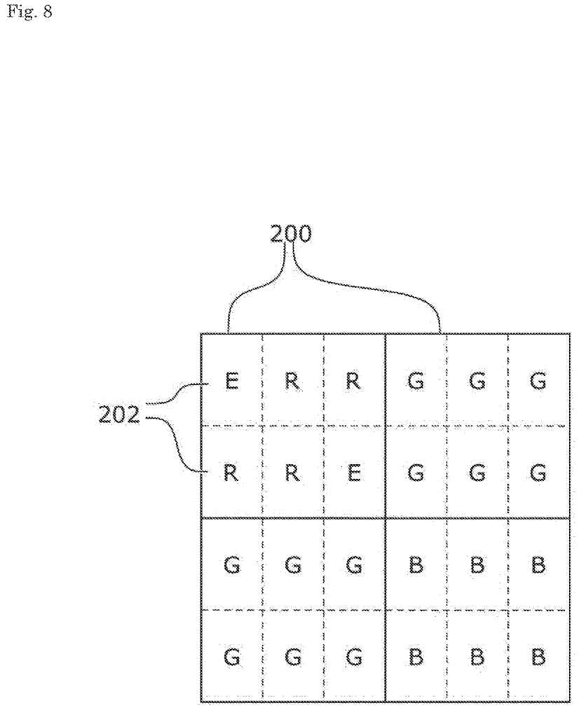

FIG. 8 is a diagram showing an example in which the pixel 200 is divided into 3×2. As shown in FIG. 8, 3×2 divided pixels 202 may be provided within the pixel 200. In this case as well, the pixel 200 that receives the R light may include the divided pixels 202 that receive the E light in a proportion equal to or less than the proportion of the divided pixels 202 that receive the R light. Furthermore, as in the case of FIG. 5 and the like, the pixel 200 may include divided pixels such that the center of gravity of the divided pixel 202 that receives the R light is aligned with the center of gravity of the divided pixel 202 that receives the E light.

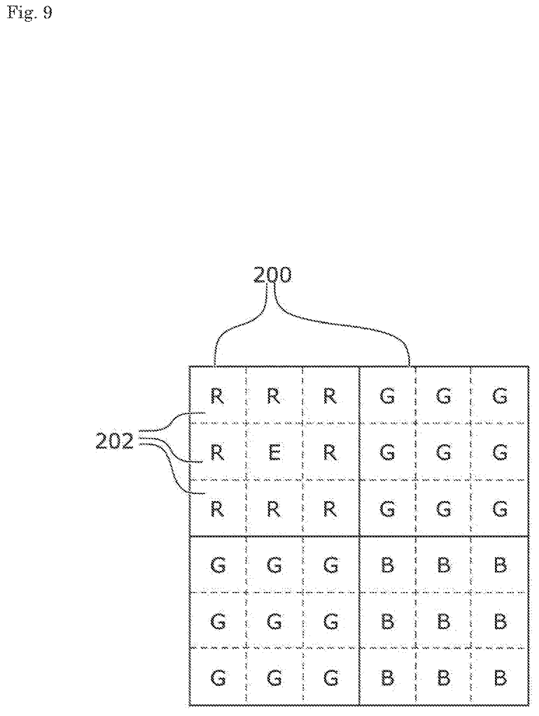

FIG. 9 is a diagram showing an example in which the pixel 200 is divided into 3×3. As shown in this figure, pixel 200 may be divided into 3×3 divided pixels 202. In the pixel 200 that receives the R light, the central pixel may be a divided pixel 202 that receives the E light. In this case, in the pixel 200, the center of gravity of the divided pixel 202 that receives the R light can be aligned with the center of gravity of the divided pixel 202 that receives the E light.

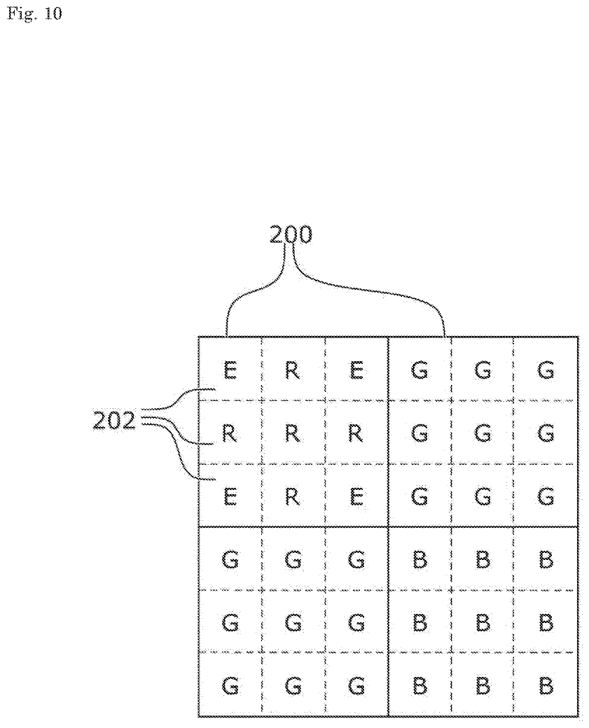

FIG. 10 is a diagram showing another example in which the pixel 200 is divided into 3×3. The pixel 200 is divided into 3×3 divided pixels 202. Among the divided pixels 202 in the pixel 200 that receives the R light, the divided pixels 202 that are the diagonal components may be formed as the divided pixels 202 that receive the E light. In this case as well, in the pixel 200, the center of gravity of the divided pixel 202 that receives the R light can be aligned with the center of gravity of the divided pixel 202 that receives the E light.

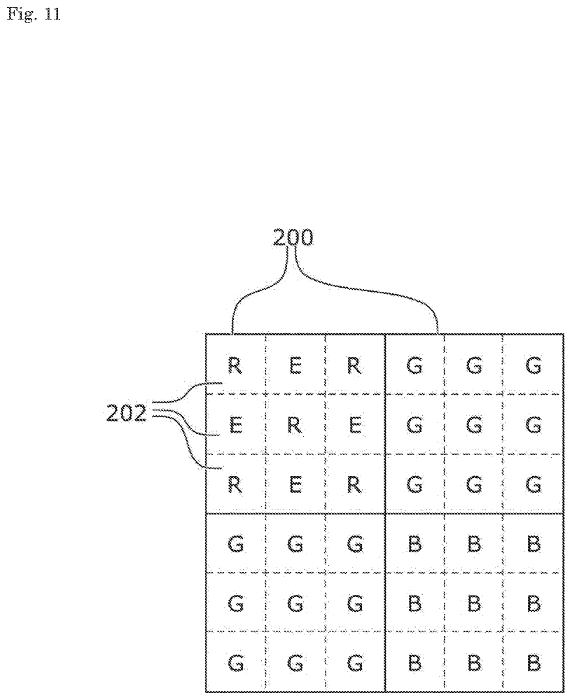

FIG. 11 is a diagram showing yet another example in which the pixel 200 is divided into 3×3. In the pixel 200 that receives the R light, the divided pixels 202 that receive the R light may be arranged at the center and diagonally, and the other divided pixels 202 may be the divided pixels 202 that receive the E light. In this case as well, in the pixel 200, the center of gravity of the divided pixel 202 that receives the R light can be aligned with the center of gravity of the divided pixel 202 that receives the E light.

In any of the examples in FIGS. 9 to 11, in the pixel 200 that receives the R light, the proportion of the divided pixels 202 that receive the R light is higher than the proportion of the divided pixels 202 that receive the E light.

The pixel 200 may include a larger number of divided pixels 202, for example, 4×4, 5×5, or more divided pixels. Even in these cases, as described above, in the pixel 200 that receives the R light, it is desirable that the proportion of the divided pixels 202 that receive the R light is higher than the proportion of the divided pixels 202 that receive the E light. Similarly, in the pixel 200, it is desirable that the center of gravity of the divided pixel 202 that receives the R light is aligned with the center of gravity of the divided pixel 202 that receives the E light. As a condition that satisfies both simultaneously, for example, as shown in FIGS. 5 and 10, in the pixel 200 that receives the R light, the divided pixels 202 positioned at the diagonal corners may be used as the divided pixels 202 that receive the E light. Extension as shown in each figure is also possible.

Although the case where all the pixels 200 are provided with the divided pixels 202 has been described using a plurality of examples, the present invention is not limited to these.

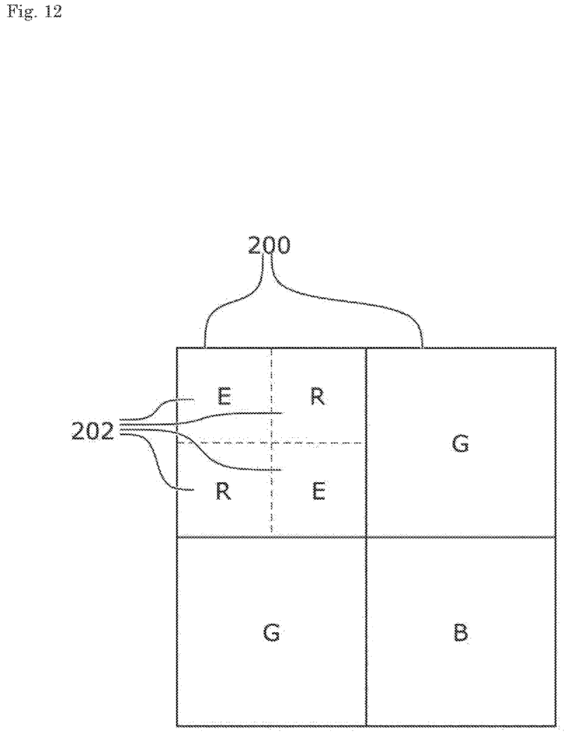

FIG. 12 is a diagram showing how the pixel 200 is divided according to one embodiment. As shown in this figure, for example, only a pixel 200 that receives the R light may have the divided pixel 202, and the pixels 200 that receive the G and B light may not be divided. By forming the pixel 200 in this way, it is possible to reduce the influence of the division into the divided pixels 202 in the pixels 200 that receive the G and B light. Other examples other than FIG. 5 can be similarly implemented.

Next, the case where the pixel 200 is provided with an on-chip lens will be described. The imaging element 2 may optionally include an on-chip lens for the pixels 200. The shape of the on-chip lens in the pixel 200 can also be changed depending on the information to be acquired. That is, the pixel 200 can have an on-chip lens of an arbitrary shape.

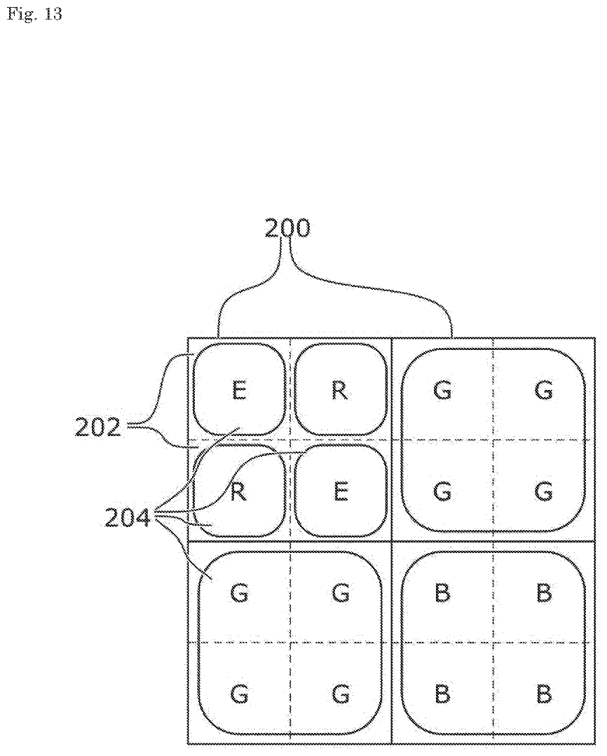

FIG. 13 is a diagram showing an example with an on-chip lens in the example of FIG. 5. As shown in the figure, the pixel 200 may include an on-chip lens 204.

For example, the pixels 200 that receive the G and B light may be provided with an on-chip lens so as to cover the entire pixel 200. On the other hand, for the pixel 200 that receives the R light, the on-chip lens 204 may be provided for each of the divided pixel 202 that receives the R light and the divided pixel 202 that receives the E light. By providing the on-chip lens 204 in this way, in the pixels 200 that receive the G and B light, the imaging element 2 can appropriately convert the light received in that region into a signal. Furthermore, in the divided pixels 202 that receive the R and E light, the imaging element 2 can appropriately acquire the light intensity for each region in the pixel 200.

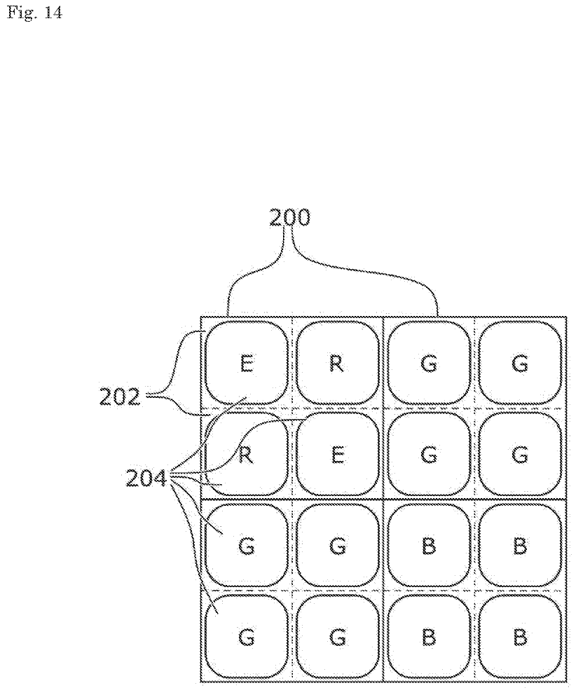

FIG. 14 is a diagram showing a different arrangement of the on-chip lenses 204. As shown in this figure, the pixels 200 that receive the G and B light may also be provided with an on-chip lens 204 so as to converge the light on each divided pixel 202.

That is, the on-chip lenses 204 for the divided pixels 202 for receiving the R and E light and the divided pixels 202 for receiving the G and B light may have the same shape and arrangement as shown in FIG. 14 or may be different as shown in FIG. 13.

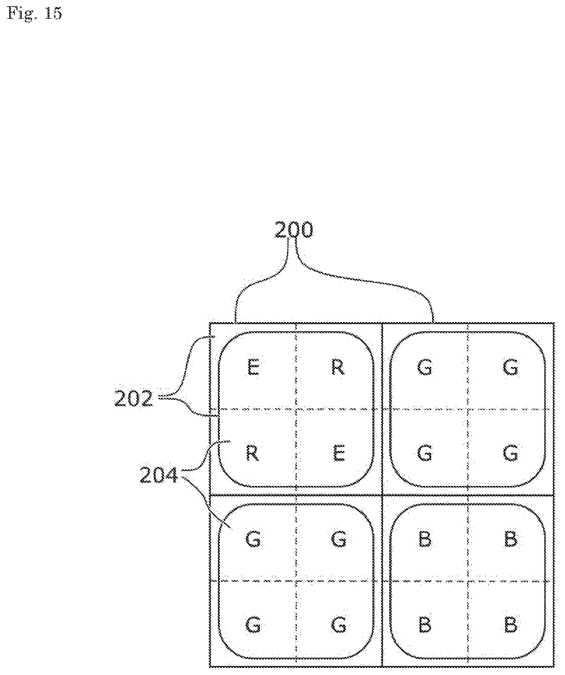

FIG. 15 is a diagram showing still another example of the on-chip lens 204. As shown in this figure, in contrast to FIG. 14, the shape of the divided pixels 202 that receive the R and E light may be a shape that covers the entire pixel 200. For example, when the divided pixels 202 for receiving the R and E light are provided diagonally within the pixel 200, such a shape and arrangement are also possible.

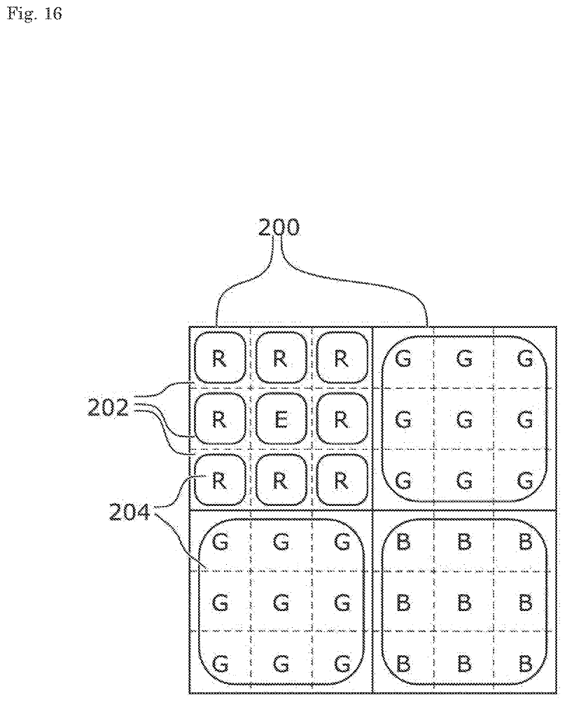

FIG. 16 is a diagram showing an example with the on-chip lens 204 when the pixel 200 is divided into 3×3. As in the case of FIG. 13, in the pixel 200 that receives the R light, the on-chip lens 204 may be provided for each divided pixel 202. On the other hand, in the pixels 200 that receive the G and B light, the on-chip lens 204 may be provided for each pixel 200.

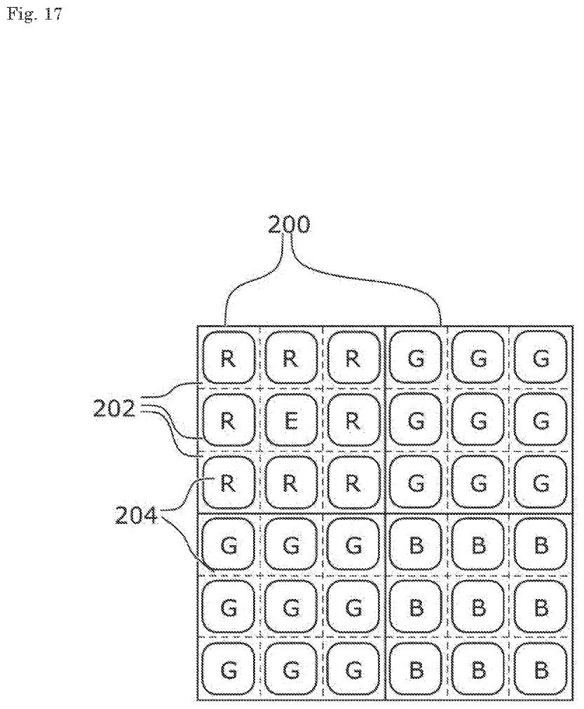

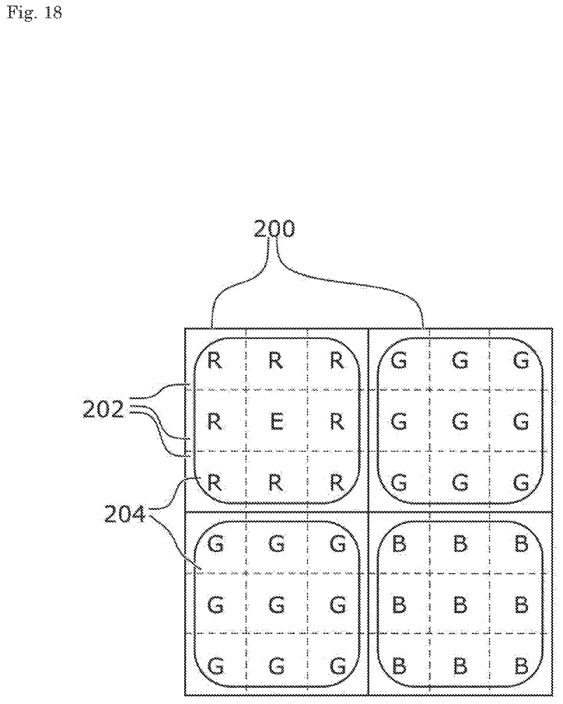

FIGS. 17 and 18 are diagrams showing another example of the arrangement of the on-chip lenses 204 when the pixel 200 is divided into 3×3.

In this way, it is possible to extend the arrangement of the on-chip lenses 204 shown in FIGS. 13, 14, 15, and the like to the 3×3 division or more of the pixel 200.

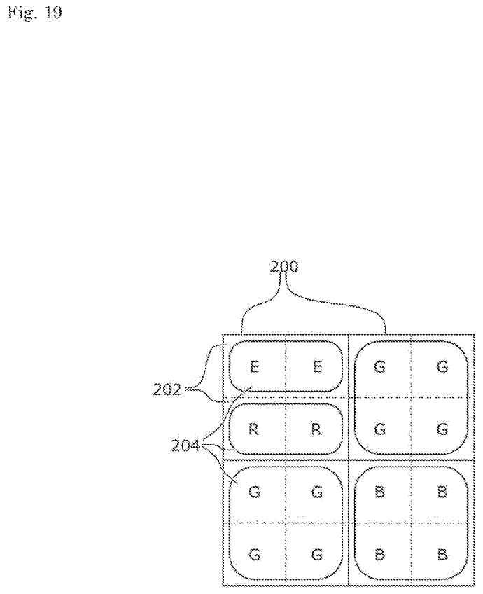

FIG. 19 is an example of the arrangement of divided pixels 202 different from the above when the on-chip lens 204 is provided. As shown in FIG. 19, the pixel 200 that receives the R light may have adjacent divided pixels 202, for example, two horizontally adjacent divided pixels 202 that receive the R light and two horizontally adjacent divided pixels 202 that receive the E light.

In such an arrangement, as shown in the figure, one on-chip lens 204 is arranged so as to cover two divided pixels 202 that receive the R light within the pixel 200 that receives the R light. One on-chip lens 204 may be arranged so as to cover two divided pixels 202 that receive the E light. Thus, the on-chip lens 204 may be formed in a shape based on a rectangular shape instead of a shape based on a square shape.

By using the on-chip lens 204 for the 2×1 divided pixels 202, for example, it is possible to obtain a phase difference within the pixel 200 that receives the R light.

As described above, according to the present embodiment, when there is a region in which the negative values of the color-matching functions of the three primary colors are large in an imaging element having a configuration in which a pixel is divided, by arranging a divided pixel of the fourth color having a peak in the wavelength region corresponding to the region, it is possible to suppress various influences that depend on the spectrum that can be received by the light-receiving element.

For example, when using the three primary colors of RGB, by providing an emerald divided pixel having a peak near 520 nm (for example, a region of 520 nm±10 nm) where the negative values of these color-matching functions are large, it is possible to suppress deterioration of image quality that depends on the negative-value region of the R color-matching function. Furthermore, by arranging the divided pixel that receives the emerald light in the pixel that receives the R light, it becomes possible to share the pixel circuit. Moreover, the center of gravity of the emerald divided pixel can be aligned with the divided pixel that receives the R light, and the influence of misalignment such as false colors can be suppressed.

Next, signal processing of the imaging element 2 in the first embodiment will be described.

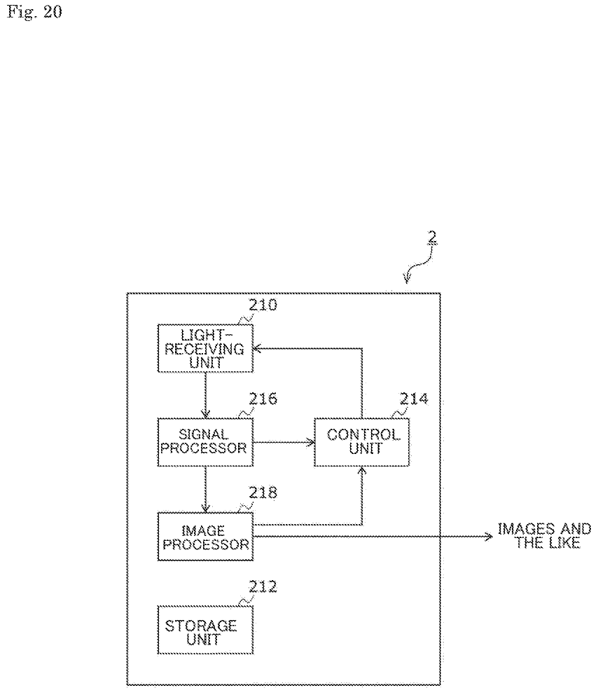

FIG. 20 is a block diagram showing an example of the configuration of the imaging element 2. The imaging element 2 includes a light-receiving unit 210, a storage unit 212, a control unit 214, a signal processor 216, and an image processor 218, for example. The imaging element 2 is an element that appropriately processes the light received by the light-receiving unit 210, converts it into image information and the like, and outputs the information. Each of these units may be implemented as a circuit at an appropriate location.

The light-receiving unit 210 receives light from the outside and outputs a signal based on the intensity of the received light. The light-receiving unit 210 includes the pixel array 20 described above, and may further include an optical system that allows light to enter the pixel array 20 appropriately.

The storage unit 212 stores data necessary for each component of the imaging element 2 or data output from each component. The storage unit 212 may include a memory, a storage, or the like which is an arbitrary suitable transitory or non-transitory storage medium.

The control unit 214 controls the light-receiving unit 210 and the like. For example, the control unit 214 may perform control based on an input from the user, or may perform control based on preset conditions. Further, the control unit 214 may perform control based on outputs from the signal processor 216, the image processor 218, and the like.

The signal processor 216 appropriately processes the signal output from the light-receiving unit 210 and outputs the processed signal. The signal processor 216 may include, for example, the ADC described above. In addition to this, processing such as signal clamping processing may be executed. For example, the signal processor 216 converts the analog signal acquired by the light-receiving unit 210 into a digital signal using the ADC, and outputs the digital signal to the image processor 218. By controlling the input signal to the counter as described above for the analog signal from the pixel 200 for receiving the R light, a digital signal reflecting the signal from the divided pixel 202 for receiving the E light may be output.

As another example, the signal obtained by the divided pixel 202 that receives the E light may be output separately from the R signal. In this case, the R signal may be the signal corrected using the E signal. That is, the signal processor 216 may output the corrected R signal and the G, B, and E signals.

Further, the signal processor 216 may correct the signal output from the pixel 200 for receiving the B light based on the signal output from the divided pixel 202 for receiving the E light. By performing such correction, even when the imaging element 2 is provided below the display 4, it is possible to appropriately correct the blue light component whose intensity is weakened due to absorption.

The image processor 218 generates and outputs an image signal and a video signal based on the signal output from the signal processor 216. For example, the image processor 218 may use the R, G, B, and E signals output by the signal processor 216 to improve the color reproducibility of the image. It is also possible to realize light source estimation based on the intensity of light of each color received by each light-receiving element. Some or all of these processes may be performed in the signal processor 216 instead of the image processor 218.

The image processor 218 may implement color reproducibility improvement processing using each of the R, G, B, and E signals, for example, using a model trained by machine learning. In this case, the arithmetic processing may have a form in which information processing by software is specifically implemented using a processing circuit. The software processing may be implemented, for example, by a processing circuit executing a program stored in the storage unit 212 based on parameters stored in the storage unit 212, or a dedicated processing circuit executing the software processing.

The imaging element described above can also be used in an electronic device that acquires changes in oxygen saturation in blood from spectral curves. The spectral curve of the oxygen saturation in blood does not have a large difference in the received light of B, E, and G, and the light source effect is corrected in this region. In such a case, by receiving the E light, it is possible to perform correction using the signals acquired in the wavelength region with three types of peaks, and the accuracy can be improved as compared with the case of performing correction from two types of signals B and G. This correction may be performed by the signal processor 216 or the image processor 218, for example.

On the other hand, since the output starts to deviate depending on the oxygen saturation in the R region, by obtaining the oxygen saturation from this feature, it is possible to estimate the oxygen saturation in visible light. In this case, pixels that receive infrared light or divided pixels may be partially introduced.

When a similar electronic device is used to measure heart rate, it is necessary to capture changes in blood color in real time. Even in such a case, accuracy can be improved by realizing light source estimation and external light removal.

In this way, based on the digital signal output from the signal processor 216 (or the image processor 218), processing for improving the sensing accuracy of the received light, for example, color reproducibility improvement, light source estimation, external light removal may be performed.

Note that the combinations of the three primary colors and the fourth color are not limited to the above. As in the above, for example, three primary colors that are sufficiently capable of reproducing the visible light region may be set. In color reproduction using these three primary colors, if the negative values of the color-matching functions of these three primary colors can affect the execution of highly accurate color reproduction, the fourth color that can cover the negative-value region may be set.

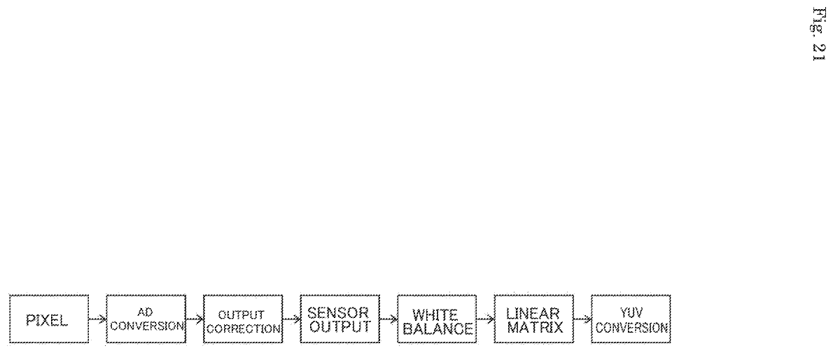

FIG. 21 is a diagram more specifically showing the data flow in the imaging element. For example, each data processing is executed by an appropriate component among the light-receiving unit 210 to the image processor 218 in FIG. 20.

A pixel outputs an analog signal photoelectrically converted by a light-receiving element of the pixel. This analog signal is suitably converted to a digital signal in the ADC. As described above, during AD conversion, this digital signal may obtained by subtracting the received light intensity of the emerald light from the received light intensity of the R light.

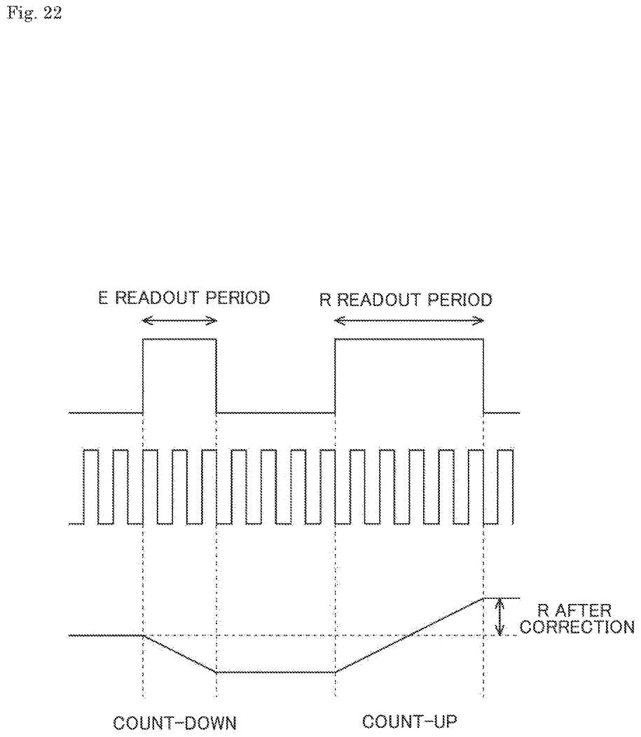

FIG. 22 is a diagram showing how this AD conversion is performed. When subtracting the emerald intensity from the R intensity during AD conversion, it can be implemented by down-counting during the E readout period and up-counting during the R readout period, as shown in this figure. By performing subtraction processing in this way, it is possible to correct the R light based on the received light intensity of execution history E light at the time of AD conversion.

For example, when CDS has a part of the timing chart shown in FIG. 22, the reset period starts before the E readout period, and the reset level is reached. E-readout is executed by down-counting from this reset level. Subsequently, a data readout period is started, and R-readout is executed by up-counting. By processing in this manner, in the AD conversion, a value obtained by subtracting the E signal from the R signal can be output from the counter. Naturally, other implementations are also possible in CDS, and in cases other than CDS, E-readout can be executed by down-counting.

When the E signal is multiplied by the gain, for example, the ramp signal used for counting the E signal is controlled to have a slope different from that of the R signal, or the frequency of the clock signal that indicates the count timing of the E signal may be controlled.

Similar processing can be performed when the intensity of the E signal is used to correct the intensity of the B signal. That is, by considering up-counting during the E readout period and up-counting during the B readout period, the B signal can be corrected using the E signal during AD conversion.

When performing correction using the E signal during AD conversion, the ADC performs the processing as described above.

Once converted to a digital signal by the ADC, corrections are performed on this digital signal. This signal correction may be performed externally rather than within the imaging element. The corrections for the E signal may be performed at this stage.

Regardless of whether the correction is performed in the imaging element or not, as described above, the three color signals in which the E signal was used for correction may be output to sensors, and four color signals including the E signal may be output to external sensors.

White balance adjustment, linear matrix processing, and YUV conversion are performed and output as appropriate image signals. If correction is not executed before sensor output, correction using the E signal may be executed during white balance processing, linear matrix processing, and YUV processing.

It should be noted that the above processing is given as an example, and is not limited to this processing flow.

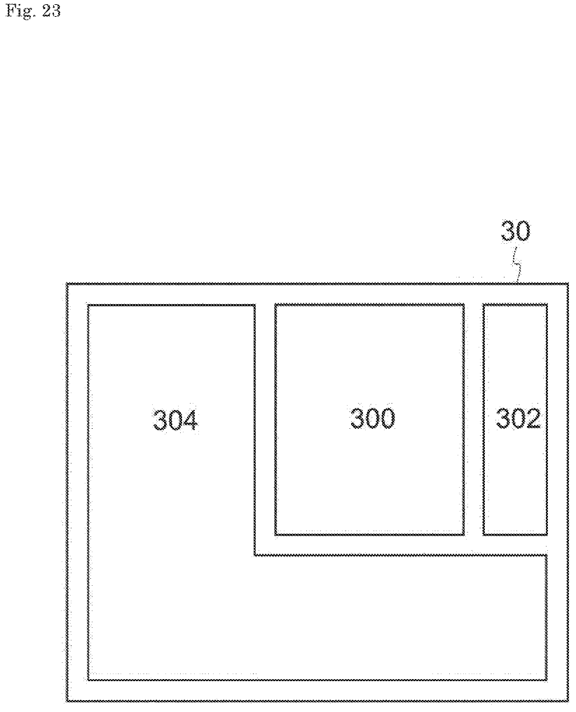

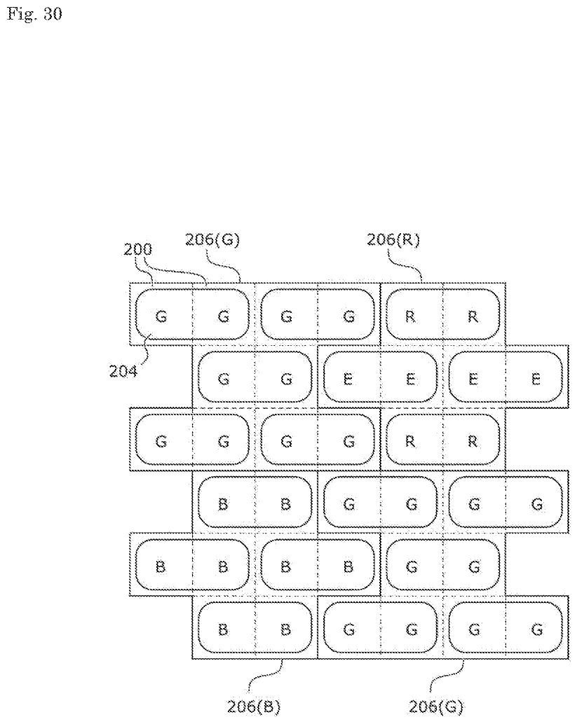

FIG. 23 is a diagram showing an example of a substrate provided with the imaging element 2. A substrate 30 includes a pixel region 300, a control circuit 302, and a logic circuit 304. As shown in FIG. 30, the pixel region 300, the control circuit 302, and the logic circuit 304 may be provided on the same substrate 30.

The pixel region 300 is, for example, a region in which the pixel array 20 and the like described above are provided. The pixel circuit and the like described above may be appropriately provided in this pixel region 300 or may be provided in another region (not shown) of the substrate 30. The control circuit 302 includes the control unit 214. The logic circuit 304, for example, the ADC of the signal processor 216 may be provided in the pixel region 300 and may output the converted digital signal to the logic circuit 304. Further, the image processor 218 may be provided in this logic circuit 304. Moreover, at least part of the signal processor 216 and the image processor 218 may be mounted on another signal processing chip provided at a location different from the substrate 30 instead of on this chip, or may be mounted on another processor.

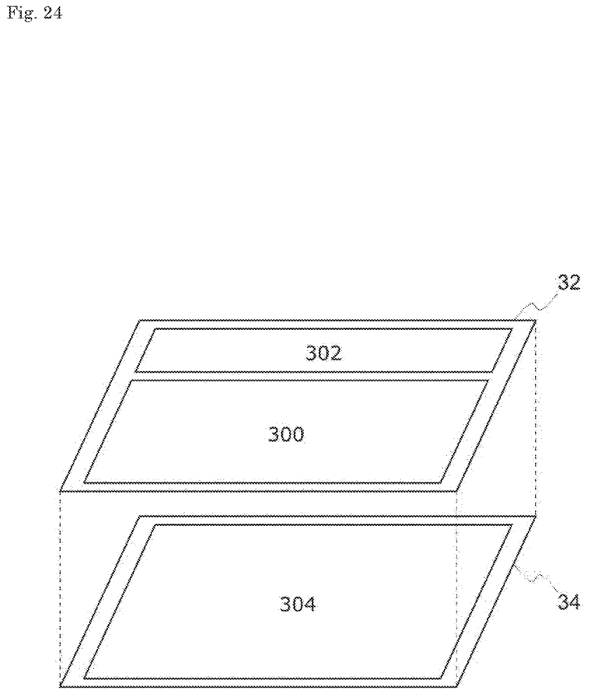

FIG. 24 is a diagram showing another example of a substrate provided with the imaging element 2. As substrates, a first substrate 32 and a second substrate 34 are provided. The first substrate 32 and the second substrate 34 have a laminated structure, and can transmit and receive signals to and from each other appropriately through connection portions such as via holes. For example, the first substrate 32 may include the pixel region 300 and the control circuit 302, and the second substrate 34 may include the logic circuit 304.

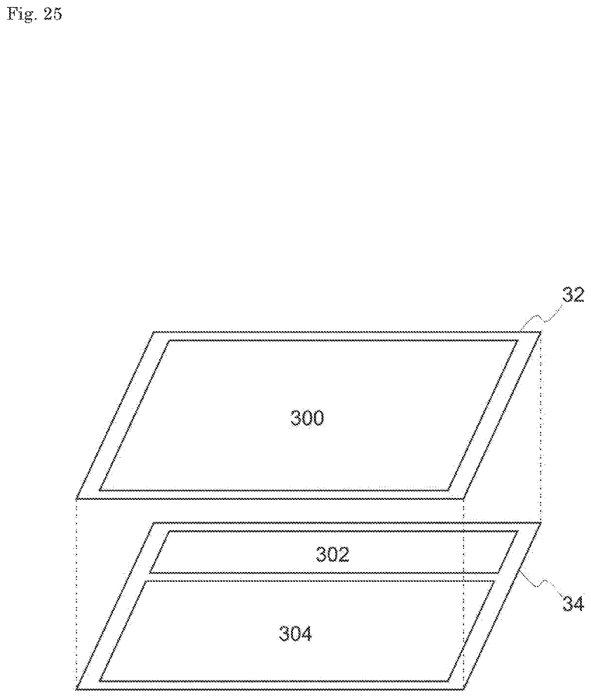

FIG. 25 is a diagram showing another example of a substrate provided with the imaging element 2. As substrates, a first substrate 32 and a second substrate 34 are provided. The first substrate 32 and the second substrate 34 have a laminated structure, and signals can be transmitted and received to and from each other appropriately through connection portions such as via holes. For example, the first substrate 32 may include the pixel region 300 and the second substrate 34 may include the control circuit 302 and the logic circuit 304.

In addition, in FIGS. 23 to 25, the storage region may be provided in any region. In addition to these substrates, a substrate for the storage region may be provided, and this substrate may be provided between the first substrate 32 and the second substrate 34 or below the second substrate 34.

A plurality of laminated substrates may be connected to each other through via holes as described above, or may be connected by a method such as micro-dumping. These substrates can be laminated by any method such as CoC (Chip on Chip), CoW (Chip on Wafer), or WoW (Wafer on Wafer).

### Modification

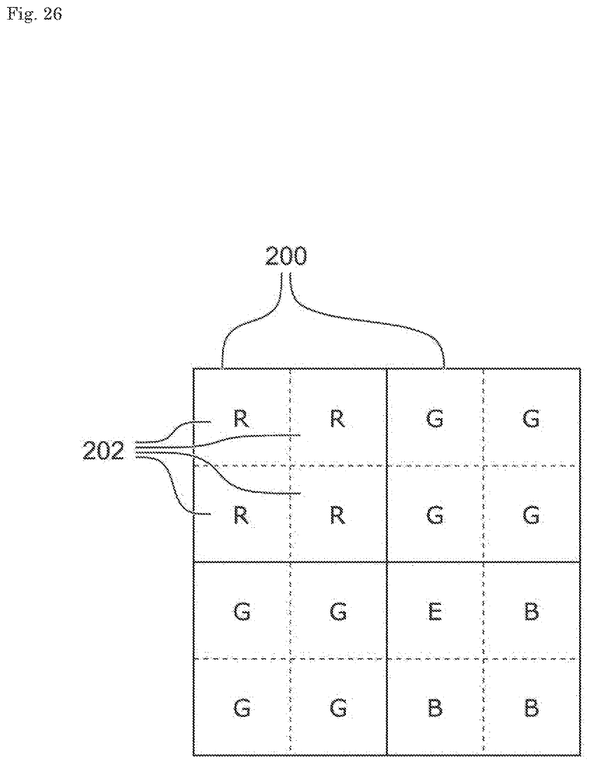

FIG. 26 is a diagram showing a modification of the arrangement of pixels according to one embodiment. As shown in this figure, a divided pixel 202 for receiving the E light may be provided in a divided pixel 202 in the B pixel instead of the R pixel. In the case of correcting the B signal using the E signal in the imaging element 2, it is possible to adjust the intensity of light within the same pixel 200 by adopting such a configuration.

For example, it is known that the display 4 containing polyimide as a material has a large signal loss in the wavelength region of 500 nm or less, especially in the blue wavelength region. Therefore, the E signal may be used to correct the signal in this wavelength region.

Specifically, the loss may be compensated by simply adding the E signal value to the B signal value.

Further, when the output is corrected by multiplying the B signal by a gain, the output of B in the wavelength region near 520 nm where loss is small is over-corrected. As a result, the spectral balance may be lost. In order to maintain this spectral balance, the value obtained by multiplying the output value of the E signal by the gain may be subtracted from the value obtained by multiplying the output value of the B signal by the gain.

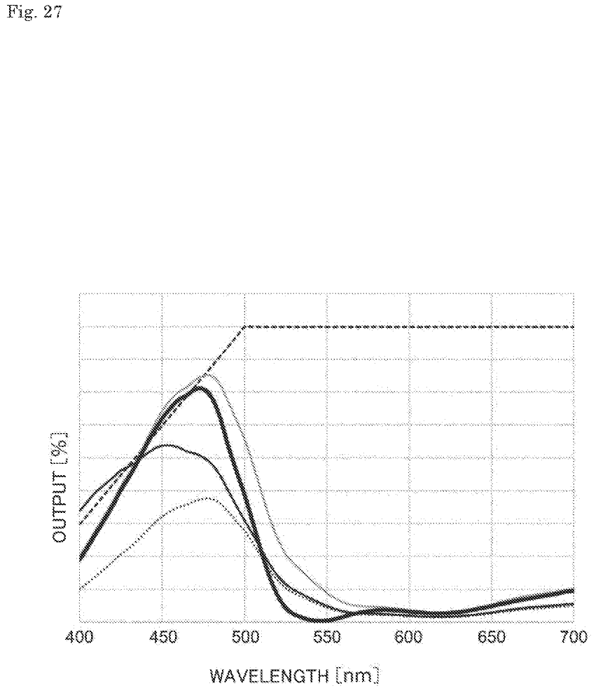

FIG. 27 is a graph showing relative output values for wavelengths when polyimide is used as the material. The dashed line indicates the transmittance of polyimide. The thin solid line shows the output for the wavelengths that make up the B light when not transmitted through polyimide. The dotted line shows the attenuated output for the B wavelength when transmitted through polyimide. The thin line shows the curve where the output of the dotted line is doubled (multiplied by the gain). The thick solid line indicates the output obtained by subtracting the output of the wavelengths forming the E light at a constant rate from the output of the thin line.

Polyimide used in displays causes loss in the blue wavelength region, as indicated by the dashed line. Therefore, in order to compensate for the output (thin solid line) of the pixel 200 that receives light in the blue wavelength region, that is, outputs the B signal, gain is added to the B signal in the signal processing as indicated by the thin line.

On the other hand, when the signal is multiplied by the gain in this way, the output in the wavelength region of 500 nm to 550 nm, where loss due to polyimide is small, is over-corrected. Since this over-corrected wavelength region is also the emerald wavelength region, it is possible to adjust the spectral shape by subtracting the E signal at an appropriate ratio from the output of the dashed-dotted line.

In this way, the output of the pixel 200 that receives the B light may be corrected using the E signal. In this case, as shown in FIG. 26, it is more desirable that the divided pixel 202 for receiving the E light is provided in the pixel 200 for receiving the B light.

Naturally, FIG. 26 is shown as an example, and similar to the case where the pixel 200 that receives the R light is provided with the divided pixel 202 that receives the E light, the pixel 200 may be configured as shown in FIGS. 5 to 19, or as shown in FIGS. 30 to 32, which will be described later.

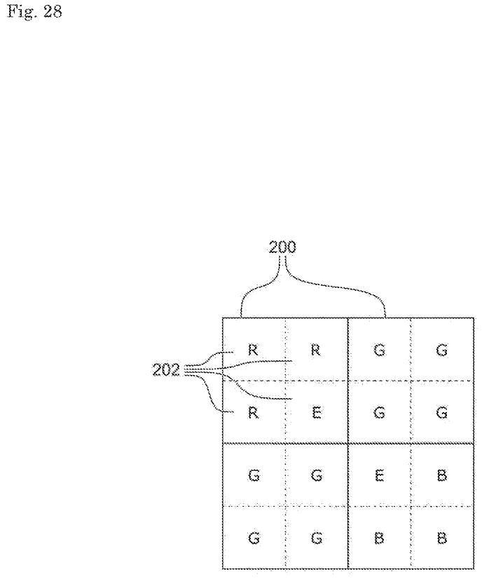

FIG. 28 is a diagram showing still another example of the pixel arrangement. As shown in this figure, each of the pixel 200 that receives the R light and the pixel 200 that receives the B light may be provided with a divided pixel 202 that receives the E light. In this case, the output from the E divided pixel 202 provided in each pixel 200 can be used for the R correction and the B correction.

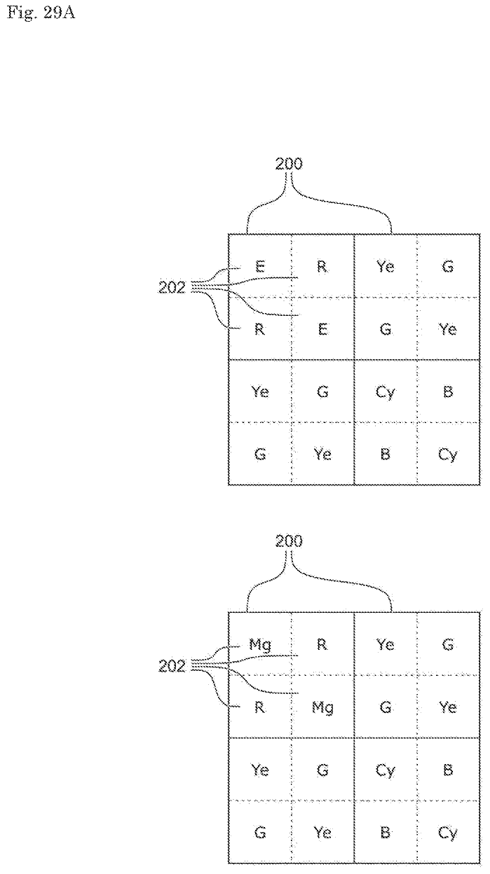

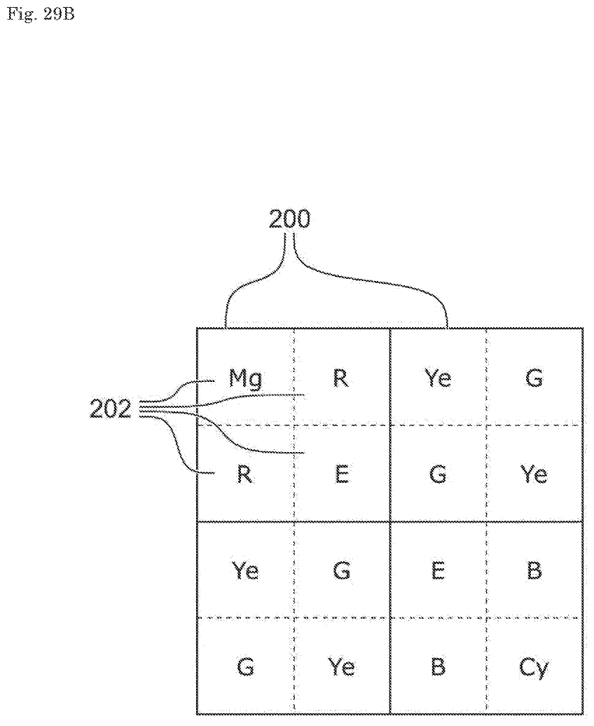

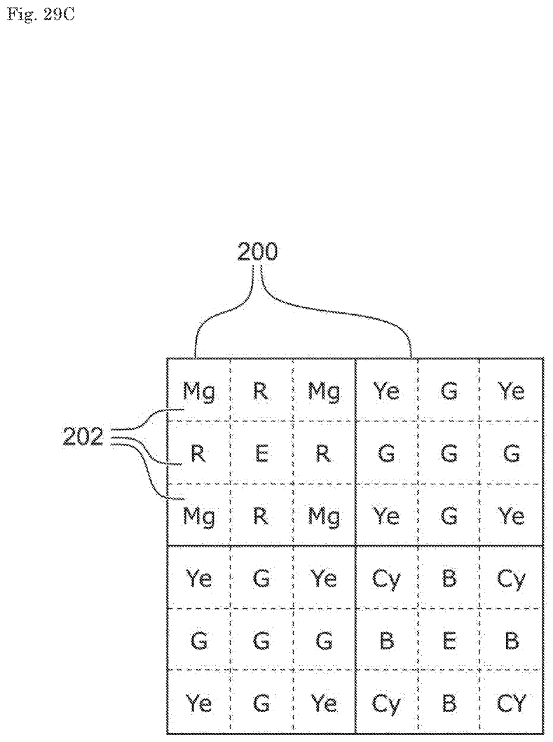

FIG. 29A is a diagram showing still another example of the pixel arrangement. The colors of the signals obtained by the divided pixels 202 in the pixel 200 may not be three colors. For example, E divided pixels 202 may be provided in addition to four or more colors.

As a non-limiting example, as shown in FIG. 29A, a divided pixel 202 that receives the E light may be provided in addition to the divided pixels 202 that receive complementary colors other than the three primary colors.

For example, as shown in the upper figure, the imaging element 2 includes, in the pixel 200 that receives the R light, a divided pixel 202 that receives the R light and a divided pixel 202 that receives the E light. In the pixel 200 that receives the G light, the imaging element 2 includes a divided pixel 202 that receives the G light and a divided pixel 202 that receives yellow (Ye) light. In the pixel 200 that receives the B light, the imaging element 2 includes a divided pixel 202 that receives the B light and a divided pixel 202 that receives cyan (Cy) light. Thus, the complementary colors of the three primary colors may be appropriately provided as divided pixels 202.

As another example, as shown in the lower figure, the imaging element 2 includes, in the pixel 200 that receives the R light, a divided pixel 202 that receives the R light and a divided pixel 202 that receives magenta (Mg) light. In the pixel 200 that receives the G light, the imaging element 2 includes a divided pixel 202 that receives the G light and a divided pixel 202 that receives the Ye light. In the pixel 200 that receives the B light, the imaging element 2 includes a divided pixel 202 that receives the B light and a divided pixel 202 that receives the E light. In this manner, the divided pixel 202 for receiving the E light may be provided in the pixel 200 for receiving the B light instead of the pixel 200 for receiving the R light as in the above-described embodiment.

FIG. 29B is a diagram showing still another example of the pixel arrangement. As shown in FIG. 28, each of the pixel 200 that receives the R light and the pixel 200 that receives the B light may be provided with a divided pixel 202 that receives the E light. That is, in the pixel 200 that receives the R light, the imaging element 2 includes a divided pixel 202 that receives the R light, a divided pixel 202 that receives the Mg light, and a divided pixel 202 that receives the E light. In the pixel 200 that receives the G light, the imaging element 2 includes a divided pixel 202 that receives the G light and a divided pixel 202 that receives the Ye light. In the pixel 200 that receives the B light, the imaging element 2 includes a divided pixel 202 that receives the B light, a divided pixel 202 that receives the Cy light, and a divided pixel 202 that receives the E light.

The signal processor 216 can correct the intensity of light in a wavelength region that is difficult to obtain in the wavelength region of the received color by using the reception result of the complementary color light. For this reason, as shown in these figures, a form including a divided pixel 202 that receives light of a complementary color may be provided. As shown in FIG. 29A, by aligning the center of gravity of the divided pixel 202 that receives the complementary color or E light with the center of gravity of the divided pixel 202 that receives light of the three primary colors, it is possible to suppress the occurrence of false colors in correction. On the other hand, as shown in FIG. 29B, by providing the divided pixel 202 for receiving the E light in the pixel 200 for receiving the R light and the pixel 200 for receiving the B light, the R and B signals can be corrected by the divided pixel 202 that receives the E light within the pixel 200.

FIG. 29C is a diagram showing still another example of the pixel arrangement. As shown in this figure, the pixel 200 may include more than 2×2 divided pixels 202 as described above.

As an example, in the pixel 200 that receives the R light, the imaging element 2 has a divided pixel 202 that receives the R light, a divided pixel 202 that receives the Mg light, and a divided pixel 202 that receives the E light. In the pixel 200 that receives the G light, the imaging element 2 includes a divided pixel 202 that receives the G light and a divided pixel 202 that receives the Ye light. In the pixel 200 that receives the B light, the imaging element 2 includes a divided pixel 202 that receives the B light, a divided pixel 202 that receives the Cy light, and a divided pixel 202 that receives the E light.

In this way, when the pixel 200 is provided with 3×3 divided pixels 202, for example, it is possible to align the positions of the centers of gravity of the divided pixels 202 that receive light of each color in the pixel 200. As a result, it is possible to interpolate negative values in the color-matching function to improve color reproduction by complementary colors, and to suppress the occurrence of false colors due to these corrections.

Naturally, these examples are given as non-limiting examples, and any suitable color arrangement of the divided pixels 202 may be used to achieve advantages.

### Second Embodiment

In the above-described first embodiment, a pixel is provided with divided pixels, and at least one of the divided pixels is provided with a divided pixel that receives light of a fourth color different from the three primary colors. Instead, they may be implemented as sets of pixels rather than divided pixels.

FIG. 30 is a drawing of some extracted pixels in the pixel array 20 according to one embodiment. Pixels 200 are indicated by dotted lines, and pixels 200 surrounded by solid lines indicate a pixel group 206 that receives light of the same color. These pixels may be implemented as 2×1 pairs of pixels.

The pixel group 206 may include a pixel group including 5 pixel pairs (10 pixels 200) and a pixel group including 4 pixel pairs (8 pixels 200). Each pixel pair is provided with an on-chip lens 204. As shown in the figure, a pixel group 206 with five pixel pairs receives light of G color, and a pixel group 206 with four pixel pairs receives light of R or B color. Even if such pixels 200 are assembled to receive light of the same color, part of the pixel group 206 that receives the R light can be configured as the pixels 200 that receive the E light.

For example, as shown in FIG. 30, in a pixel group 206 that receives the R light, a pixel 200 located at the center may be configured as a pixel 200 that receives the E light. This combination of E and R may be reversed.

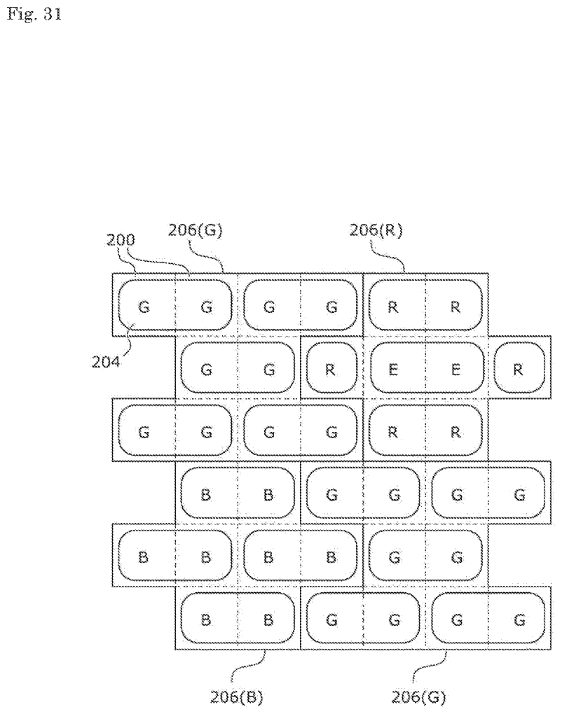

FIG. 31 is a diagram showing another combination in a configuration similarly provided with pixel groups. As shown in FIG. 31, in the pixel group 206 that receives the R light, the pixel 200 that receives the E light may be positioned at the center, and the other pixels 200 may be configured as the pixels 200 that receive the R light. In this case, one on-chip lens 204 may be provided for each of the R-light-receiving pixel pair and the E-light-receiving pixel pair, and the pixels 200 provided at both ends of the E-light-receiving pixel pair may be provided with on-chip lenses 204 corresponding to their respective sizes.

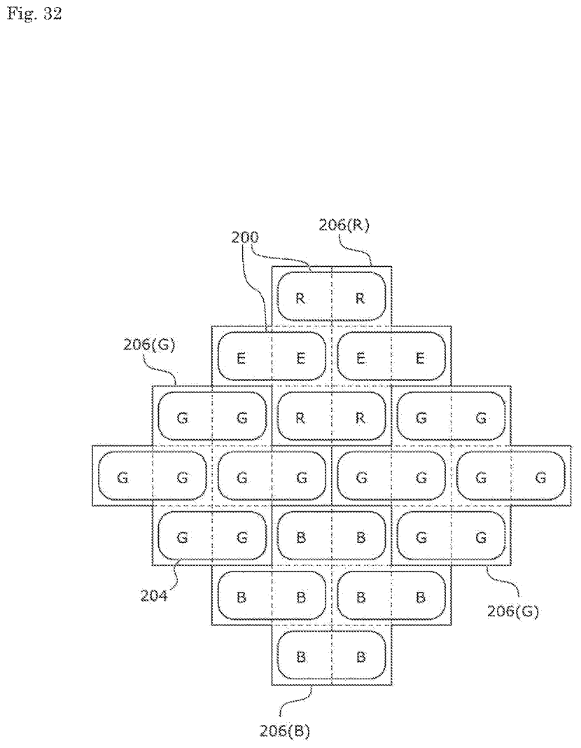

FIG. 32 is a diagram showing another example of the configuration of pixel pairs. As shown in FIG. 32, all pixel groups 206 may be formed from four pixel pairs (eight pixels 200). As in the case of FIG. 30, pixels 200 for receiving the E light are provided in the pixel group 206 for receiving the R light. By forming in this way, the proportions of the numbers of pixels 200 that acquire the signals of each color can be made the same as in the above-described embodiment. Naturally, in the form of FIG. 32, the form of the pixel group 206 that receives the R light of FIG. 31 may be employed. Further, when the pixel group is formed in this manner, the imaging element 2 may be formed to have a configuration in which the drawing is inclined by 45 degrees with respect to the first direction and the second direction in FIG. 1.

In either case, in the pixel group 206 that receives the R light, it is desirable that the proportion of the pixels 200 that receive the E light is less than or equal to the proportion of the pixels 200 that receive the R light. Similarly, in the same pixel group 206, it is desirable that the position of the center of gravity of the pixels 200 that receive the R light is aligned with the position of the center of gravity of the pixels 200 that receive the E light.

In this way, in the pixel group 206, which is a set of pixels 200 that receive light of the same color and are arranged according to a predetermined rule, as in the above-described embodiment, a part of the pixels 200 belonging to the pixel group 206 that receives the R light may be the pixels 200 that receive the E light. When pixel pairs are formed in this way, since the on-chip lens 204 is arranged in each pixel pair, the image plane phase difference can be obtained using the output signals from the pixels 200 belonging to the same pixel group 206. By using this phase difference, for example, the electronic device 1 can accurately detect the defocus amount, and as a result, it is possible to achieve highly accurate autofocus processing. Furthermore, by providing the pixels 200 that receive the E light within the pixel group 206 that receives the R light, the color reproducibility can be improved and the sensing accuracy can be improved as in the above-described embodiment.

Further, as shown in FIGS. 30 and 31, the number of pixels 200 that receive the G light can be made larger than the number of pixels 200 that receive the R and B light. By forming in this way, it is possible to more appropriately acquire luminance information in a photographed image or the like, and to improve image quality.

In the present embodiment, as in the above-described embodiment, the pixel 200 for receiving the E light may be provided in the pixel group 206 for receiving the B light instead of the pixel group 206 for receiving the R light.

In each of the above-described embodiments, the pixels 200, the divided pixels 202 and/or the pixel groups 206 (hereinafter referred to as pixels or the like) that receive the respective colors have been described using figures in which the pixels or the like basically have the same size. However, the form in the present disclosure is not limited to this.

E, Ye, Cy, or Mg pixels or the like may have higher sensitivity than the three primary RGB color pixels or the like having the same area. In such a case, the size of E, Ye, Cy, or Mg pixels or the like may be smaller than the size of RGB pixels or the like. The size of pixels or the like may be considered as the area of a unit light-receiving region, for example.

As another example, an ND filter may be provided on the light-receiving surface of E, Ye, Cy, or Mg pixels or the like or the amount of exposure may be changed.

Conversely, if the E, Ye, Cy, or Mg pixels or the like have lower sensitivity than that of the RGB pixels or the like, the area of E, Ye, Cy, or Mg pixels or the like may be larger than the area of RGB pixels or the like. Alternatively, an ND filter may be provided in the RGB pixels or the like, and the exposure amount of E, Ye, Cy, or Mg pixels or the like may be larger than that of RGB pixels or the like.

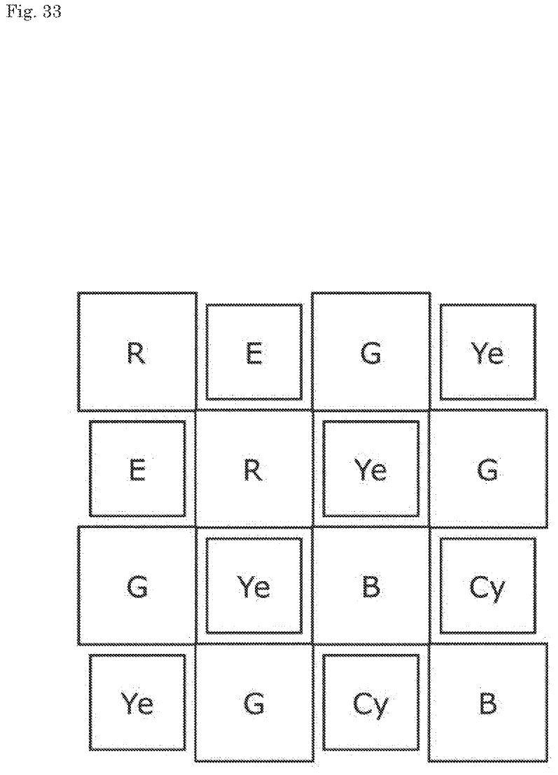

FIG. 33 is a diagram showing a non-limiting example of the pixel states described above. A case is shown in which the sensitivity of pixels for receiving E, Ye, and Cy light is higher than the sensitivity of pixels for receiving RGB colors. As shown in FIG. 33, for example, pixels that receive E, Ye, and Cy light may have light-receiving regions that are narrower than the light-receiving regions of pixels that receive RGB light.

In FIG. 33, the light-receiving regions of the pixels that receive E, Ye, and Cy light are shown to have the same size, but it is not limited to this. Depending on the light-receiving sensitivity of each pixel of E, Ye, and Cy, the light-receiving regions that receive light of these colors may have different areas.

In this manner, the area of the light-receiving region may be changed depending on the sensitivity of the pixels of each color, and an ND filter may be provided, or the exposure amount may be changed. Naturally, the present invention is not limited to these, and a configuration that can appropriately control the sensitivity may be employed.

### APPLICATION EXAMPLE OF ELECTRONIC DEVICE 1 OR IMAGING ELEMENT 2 ACCORDING TO PRESENT DISCLOSURE

### First Application Example

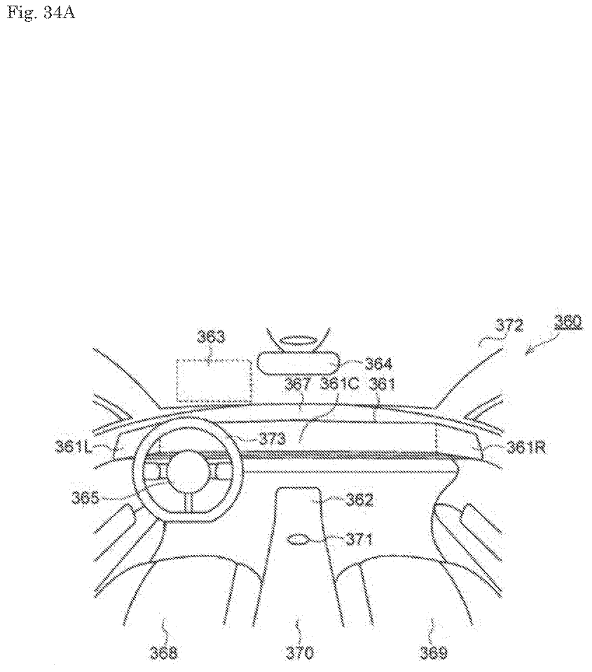

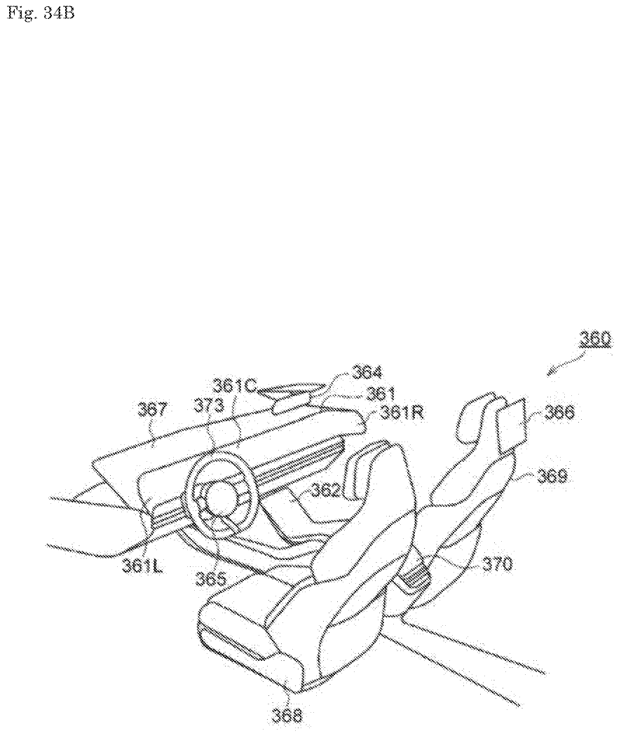

The electronic device 1 or imaging element 2 according to the present disclosure can be used for various purposes. FIGS. 34A and 34B are diagrams showing the internal configuration of a vehicle 360, which is a first application example of the electronic device 1 including the imaging element 2 according to the present disclosure. FIG. 34A is a view showing the interior of the vehicle 360 from the rear to the front of the vehicle 360, and FIG. 34B is a view showing the interior of the vehicle 360 from the oblique rear to the oblique front of the vehicle 360.

The vehicle 360 of FIGS. 34A and 34B has a center display 361, a console display 362, a head-up display 363, a digital rear view mirror 364, a steering wheel display 365 and a rear entertainment display 366.

The center display 361 is arranged on a dashboard 367 at a location facing a driver's seat 368 and a passenger's seat 369. FIG. 34 shows an example of a horizontally elongated center display 361 extending from the driver's seat 368 side to the passenger's seat 369 side, but the screen size and arrangement location of the center display 361 are arbitrary. Information detected by various sensors can be displayed on the center display 361. As a specific example, the center display 361 can display images captured by an image sensor, images of the distance to obstacles in front of and on the sides of the vehicle measured by a ToF sensor, the temperature of passengers detected by an infrared sensor, and the like. The center display 361 can be used to display at least one of safety-related information, operation-related information, lifelogs, health-related information, authentication/identification-related information, and entertainment-related information, for example.

Safety-related information includes information such as the detection of dozing, the detection of looking aside, the detection of tampering by children riding in the same vehicle, the presence or absence of seat belt wearing, and the detection of occupants being left behind, and is information detected by a sensor that is superimposed on the back side of the center display 361. The operation-related information is gestures related to the operation of the passenger detected using a sensor. Detected gestures may include operations on various devices within the vehicle 360. For example, the operation of an air conditioner, a navigation device, an AV device, a lighting device, or the like is detected. The lifelog includes lifelogs of all passengers. For example, the lifelog includes a record of each occupant's behavior during the ride. By acquiring and saving lifelogs, it is possible to check the condition of the occupants at the time of the accident. The health-related information is the body temperature of the occupant detected using a temperature sensor, and is used for estimating the health condition of the occupant based on the detected body temperature. Alternatively, an image sensor may be used to capture the image of the occupant's face, and the occupant's health condition may be estimated from the captured facial expression. Furthermore, an automated voice conversation may be conducted with the passenger, and the health condition of the passenger may be estimated based on the content of the passenger's answers. Authentication/identification-related information includes a keyless entry function that performs face authentication using a sensor, and a function that automatically adjusts seat height and position by face recognition. The entertainment-related information includes a function of detecting operation information of the AV device by the passenger using a sensor, a function of recognizing the face of the passenger with the sensor, and providing content suitable for the passenger with the AV device.

The console display 362 can be used, for example, to display lifelog information. The console display 362 is located near a shift lever 371 on the center console 370 between the driver's seat 368 and the passenger's seat 369. The console display 362 can also display information detected by various sensors. Further, the console display 362 may display an image of the surroundings of the vehicle captured by an image sensor, or may display an image of the distance to obstacles around the vehicle.

The head-up display 363 is virtually displayed behind the windshield 372 in front of the driver's seat 368. The head-up display 363 can be used to display at least one of safety-related information, operation-related information, lifelogs, health-related information, authentication/identification-related information, and entertainment-related information, for example. Since the head-up display 363 is often placed virtually in front of the driver's seat 368, the head-up display 363 is suitable for displaying information directly related to the operation of the vehicle 360, such as the speed and the fuel (battery) level of the vehicle 360.

Since the digital rear-view mirror 364 can not only show what is behind the vehicle 360, but also the rear-seat occupants, by superimposing a sensor on the back side of the digital rear-view mirror 364, it can be used for displaying lifelog information, for example.

The steering wheel display 365 is located near the center of the steering wheel 373 of the vehicle 360. The steering wheel display 365 can be used, for example, to display at least one of safety-related information, operational-related information, lifelogs, health-related information, authentication/identification-related information, and entertainment-related information. In particular, since the steering wheel display 365 is located near the driver's hands, it is suitable for displaying lifelog information such as the driver's body temperature and information regarding the operation of AV device and air conditioning device.

The rear entertainment display 366 is attached to the rear side of the driver's seat 368 or the passenger's seat 369, and is intended for viewing by passengers in the rear seats. The rear entertainment display 366 can be used to display at least one of safety-related information, operation-related information, lifelogs, health-related information, authentication/identification-related information, and entertainment-related information, for example. In particular, since the rear entertainment display 366 is in front of the rear-seat occupants, information relevant to the rear-seat occupants is displayed. For example, information on the operation of an AV device or an air conditioner may be displayed, or the results obtained by measuring the body temperature of passengers in the rear seats with a temperature sensor may be displayed.

As described above, by superimposing the sensor on the back side of the electronic device 1, the distance to the surrounding object can be measured. Optical distance measurement methods are broadly classified into passive and active types. The passive type measures distance by receiving light from an object without projecting light from the sensor to the object. The passive type includes a lens focusing method, a stereo method, a monocular vision method, and the like. The active type measures distance by projecting light onto an object and receiving reflected light from the object with a sensor. The active type includes an optical radar method, an active stereo method, a photometric stereo method, a moire topography method, an interferometric method, and the like. The electronic device 1 according to the present disclosure is applicable to any of these distance measurement methods. By using a sensor superimposed on the back side of the electronic device 1 according to the present disclosure, the passive or active distance measurement described above can be performed.

### Second Application Example

The electronic device 1 including the imaging element 2 according to the present disclosure can be applied not only to various displays used in vehicles, but also to displays mounted on various electronic devices.

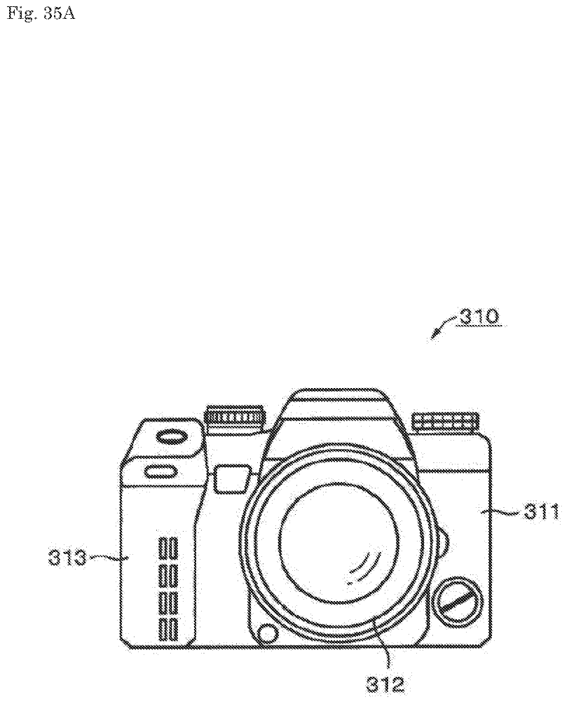

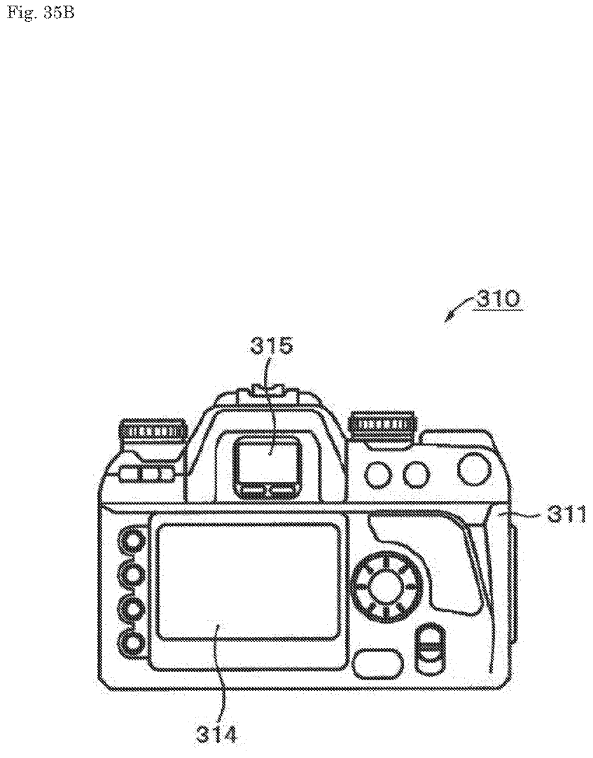

FIG. 35A is a front view of a digital camera 310, which is a second application example of the electronic device 1, and FIG. 35B is a rear view of the digital camera 310. The digital camera 310 in FIGS. 35A and 35B shows an example of a single-lens reflex camera with an interchangeable lens 121, but it can also be applied to a camera in which the lens 121 is not interchangeable.

With the camera of FIGS. 35A and 35B, when the photographer holds the grip 313 of the camera body 311, looks through the electronic viewfinder 315, determines the composition, adjusts the focus, and presses the shutter, the captured data is stored in memory. On the rear side of the camera, as shown in FIG. 35B, a monitor screen 316 for displaying photographed data and the like, a live image and the like, and an electronic viewfinder 315 are provided. In some cases, a sub-screen for displaying setting information such as shutter speed and exposure value is provided on the upper surface of the camera.

By superimposing the sensor on the back side of the monitor screen 316, the electronic viewfinder 315, the sub-screen, and the like used for the camera, it can be used as the electronic device 1 according to the present disclosure.

### Third Application Example

The electronic device 1 according to the present disclosure can also be applied to a head-mounted display (hereinafter referred to as HMD). HMDs can be used for VR, AR, MR (Mixed Reality), SR (Substitutional Reality), and the like.

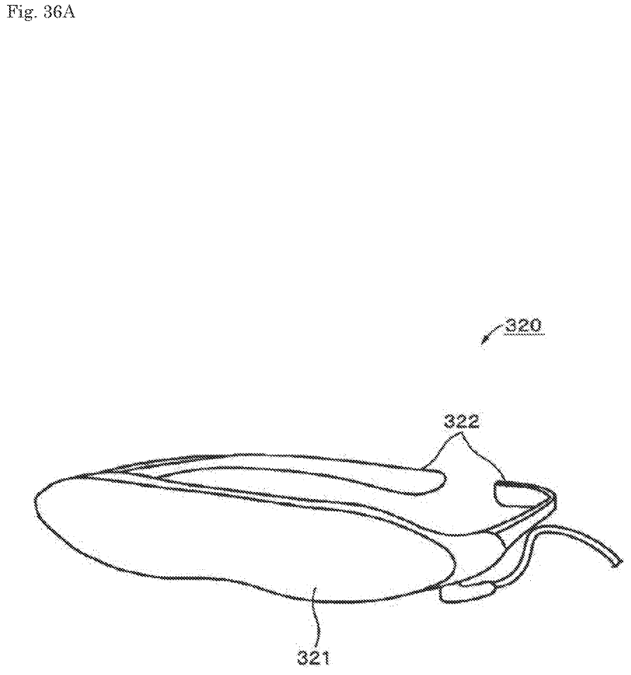

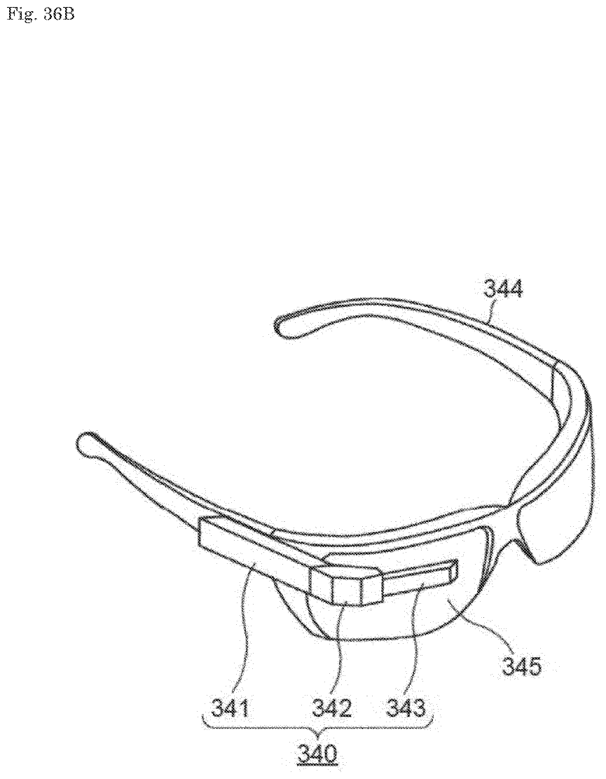

FIG. 36A is an external view of an HMD 320, which is a third application example of the electronic device 1. The HMD 320 of FIG. 36A has a mounting member 322 for wearing so as to cover the human eyes. This mounting member 322 is fixed by being hooked on the human ears, for example. A display device 321 is provided inside the HMD 320, and the wearer of the HMD 320 can visually recognize a stereoscopic image or the like on the display device 321. The HMD 320 has, for example, a wireless communication function and an acceleration sensor, and can switch stereoscopic images and the like displayed on the display device 321 according to the posture and gestures of the wearer.

Alternatively, the HMD 320 may be provided with a camera to capture an image of the wearer's surroundings, and the display device 321 may display an image obtained by synthesizing the image captured by the camera and an image generated by a computer. For example, when a camera is superimposed on the back side of the display device 321 that is visually recognized by the wearer of the HMD 320, the region around the eyes of the wearer is captured by this camera, and the captured image is displayed on another display provided on the outer surface of the HMD 320, a person around the wearer can grasp the wearer's facial expressions and eye movements in real time.

Various types of HMD 320 are conceivable. For example, as shown in FIG. 36B, the electronic device 1 according to the present disclosure can also be applied to smart glasses 340 that display various pieces of information on glasses 344. The smart glasses 340 in FIG. 36B have a body portion 341, an arm portion 342, and a lens barrel portion 343. The body portion 341 is connected to the arm portion 342. The body portion 341 is detachable from the glasses 344. The body portion 341 incorporates a control board for controlling the operation of the smart glasses 340 and a display unit. The body portion 341 and the lens barrel are connected to each other via the arm portion 342. The lens barrel portion 343 emits image light emitted from the body portion 341 via the arm portion 342 to the lens 345 side of the glasses 344. This image light enters the human eyes through the lens 345. The wearer of the smart glasses 340 in FIG. 36B can visually recognize not only the surroundings but also various pieces of information emitted from the lens barrel portion 343 in the same manner as ordinary glasses.

### Fourth Application Example

The electronic device 1 according to the present disclosure can also be applied to a television device (hereinafter referred to as TV). Recent TVs tend to have a frame as small as possible from the viewpoint of miniaturization and design. For this reason, when a camera for photographing the viewer is provided on the TV, it is desirable to superimpose the camera on the back side of the display panel 331 of the TV.

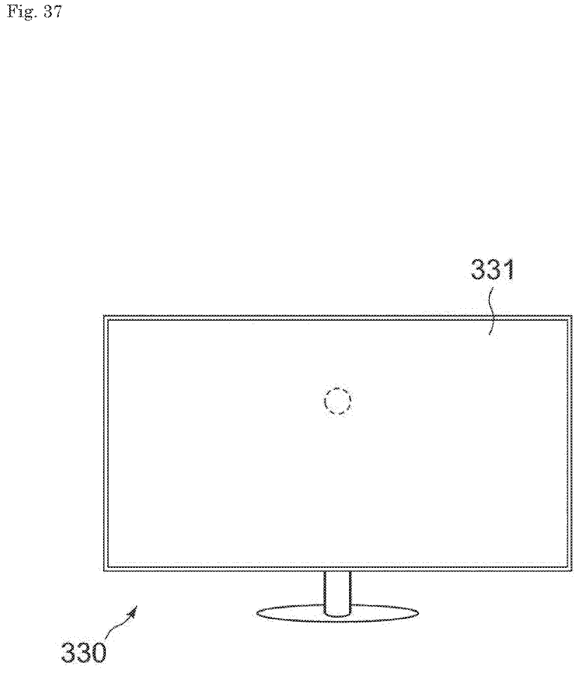

FIG. 37 is an external view of a TV 330, which is a fourth application example of the electronic device 1. The frame of the TV 330 in FIG. 37 is minimized, and almost the entire front side is the display region. The TV 330 incorporates a sensor such as a camera for photographing the viewer. The sensor in FIG. 37 is arranged behind a portion of the display panel 331 (for example, the portion indicated by the dashed line). The sensor may be an image sensor module, and various sensors such as a face authentication sensor, a distance measurement sensor, and a temperature sensor can be applied. A plurality of types of sensors may be arranged on the back side of the display panel 331 of the TV 330.

As described above, according to the electronic device 1 of the present disclosure, since the image sensor module can be superimposed on the back side of the display panel 331, there is no need to arrange a camera or the like in the frame, and the TV 330 can be miniaturized. In addition, there is no concern that the design will be damaged by the frame.

### Fifth Application Example

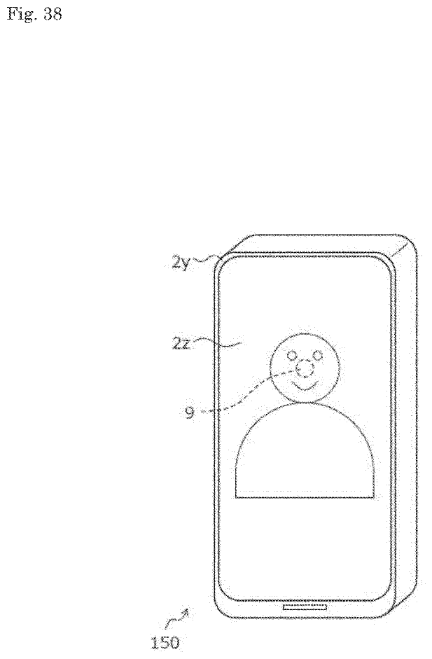

The electronic device 1 according to the present disclosure can also be applied to smartphones and mobile phones. FIG. 38 is an external view of a smartphone 350, which is a fifth application example of the electronic device 1. In the example of FIG. 38, the display surface 2z extends close to the external size of the electronic device 1, and the width of the bezel 2y around the display surface 2z is several millimeters or less. Normally, a front camera is often mounted on the bezel 2y, but in FIG. 38, an image sensor module 9 functioning as a front camera is arranged on the back side of the display surface 2z, for example, at the approximate center, as indicated by the dashed line. By providing the front camera on the back side of the display surface 2z in this way, it is not necessary to arrange the front camera on the bezel 2y, and the width of the bezel 2y can be narrowed.

The aforementioned embodiments may have the following forms.

(1)

An imaging element comprising:
pixels configured to receive light corresponding to three primary colors;
divided pixels configured to form light-receiving units in the pixels, wherein the divided pixels include:
a divided pixel configured to receive light of a first color in the pixel that receives the light of the first color among the three primary colors;
a divided pixel configured to receive the light of the first color in the pixel that receives the light of a second color among the three primary colors;
a divided pixel configured to receive the light of the first color in the pixel that receives the light of a third color among the three primary colors; and
a divided pixel configured to receive light of a fourth color different from any of the three primary colors in the pixel that receives the light of any of the three primary colors, and
a spectrum of the light of the fourth color has a maximum value in a region in which absolute values of negative values in color-matching functions of the first color, the second color, and the third color are larger than in other regions.
   (2)

The imaging element according to (1), wherein
2×2 or more divided pixels are provided in the pixel.
   (3)

The imaging element according to (2), wherein
the three primary colors are RGB (Red, Green, Blue),
a color-matching function of the fourth color has a maximum value in a wavelength range of 520 nm±10 nm, and
the number of divided pixels that receive the light of the fourth color is smaller than the number of divided pixels that receive the G light.
   (4)

The imaging element according to (3), wherein
the fourth color is emerald, and
the divided pixel that receives the light of the fourth color is at least one divided pixel among the divided pixels included in the pixel that receives the R light.
   (5)

The imaging element according to (4), wherein
the divided pixels that receive emerald light are provided, with a number thereof being in a proportion equal to or less than that of the divided pixels that receive the R light.
   (6)

The imaging element according to (5), wherein
2×2 divided pixels are provided in the pixel that receives the R light, and
the divided pixel that receives emerald light is one of the divided pixels in the pixel that receives the R light.
   (7)

The imaging element according to (5), wherein
2×2 divided pixels are provided in the pixel that receives the R light, and
the divided pixels that receive emerald light are provided in a diagonal direction, among the divided pixels in the pixel that receive the R light.
   (8)

The imaging element according to (5), wherein
3×2 or more divided pixels are provided in the pixel that receives the R light, and
a center of gravity of the divided pixels that receive the R light is aligned with a center of gravity of the divided pixels that receive the emerald light.
   (9)

The imaging element according to any one of (4) to (8), wherein
an output from the divided pixel that receives the R light is corrected using an output from the divided pixel that receives the emerald light.
   (10)

The imaging element according to (9), further comprising:
an analog-to-digital conversion circuit configured to acquire an analog signal output from the divided pixel and convert the analog signal into a digital signal, wherein
in the analog-digital conversion circuit, the R light signal and the emerald light signal are counted in opposite directions.
   (11)

The imaging element according to any one of (3) to (10), wherein
the fourth color is emerald, and
the divided pixel that receives the light of the fourth color is at least one divided pixel among the divided pixels included in the pixel that receives the B light.
   (12)

The imaging element according to (11), wherein
an output from the divided pixel that receives the B light is corrected using an output from the divided pixel that receives the emerald light.
   (13)

The imaging element according to any one of (1) to (12), wherein
the pixel includes an on-chip lens, and
the on-chip lenses provided in the pixel including the divided pixel that receives the light of the fourth color has a shape different from those of the on-chip lenses provided in the other pixels.
   (14)

The imaging element according to (12), wherein
the pixel includes an on-chip lens, and
the on-chip lens provided in the pixel including the divided pixels that receive the R and emerald light has a shape different from those of the on-chip lenses provided in the divided pixels that receive the G and B light.
   (15)

The imaging element according to any one of (4) to (12), wherein
the pixel includes an on-chip lens, and
the on-chip lens is provided so as to cover all the divided pixels in the pixel including the divided pixels that receive the R and emerald light and are arranged in a vertically and horizontally symmetrical arrangement.
   (16)

The imaging element according to (11) or (12), wherein
the pixel includes an on-chip lens, and
the on-chip lens provided in the pixel including the divided pixels that receive the B and emerald light has a shape different from that of the on-chip lenses provided in the divided pixels that receive the G and R light.
   (17)

The imaging element according to (11) or (12), wherein
the pixel includes an on-chip lens, and
the on-chip lens is provided so as to cover all the divided pixels in the pixel including the divided pixels that receive the B and emerald light and are arranged in a vertically and horizontally symmetrical arrangement.
   (18)

An imaging device comprising the imaging element according to any one of (1) to (17).

(19)

An electronic device comprising:
the imaging element according to any one of (1) to (17); and
a display having a display surface on a light-receiving surface side of the imaging element, and having the imaging device embedded therein.
   (20)

An electronic device comprising:
pixels configured to receive light corresponding to three primary colors of RGB;
2×2 or more divided pixels configured to form light-receiving units in the pixels; and
a display having a display surface on a light-receiving surface side of the pixels,
and having the pixels embedded therein, wherein
the divided pixels include:
a divided pixel configured to receive light of a first color in the pixel that receives the light of the first color among the three primary colors;
a divided pixel configured to receive light of a second color in the pixel that receives the light of a second color among the three primary colors;
a divided pixel configured to receive light of a third color in the pixel that receives the light of a third color among the three primary colors; and
a divided pixel configured to receive light of an emerald color different from any of the three primary colors in the pixel that receives the light of any one of the three primary colors, and
a spectrum of the light of the emerald color has a maximum value in a wavelength range of 520 nm±10 nm, and the number of divided pixels that receive the emerald light is smaller than the number of divided pixels that receive the G light.
   (21)

The electronic device according to (20), wherein
the display is made of a material containing a material that absorbs light in a wavelength region of 450 nm or less.
   (22)

The electronic device according to (21), wherein
the display is made of a material containing polyimide.
   (23)

The electronic device according to any one of (20) to (22), wherein
an output from the divided pixel that receives the R light is corrected based on an output from the divided pixel that receives the emerald light.
   (24)

The electronic device according to any one of (20) to (23), wherein
an output from the divided pixel that receives the B light is corrected based on an output from the divided pixel that receives the emerald light.
   (25)

The electronic device according to any one of (20) to (24), further comprising:
an analog-to-digital conversion circuit configured to convert an analog signal output from the divided pixels into a digital signal; and
a signal processing circuit configured to perform signal processing on an output of the analog-to-digital conversion circuit, wherein the signal processing circuit improves light sensing accuracy, based on the digital signal.
   (26)

The electronic device according to (25), wherein
the signal processing circuit improves color reproducibility.
   (27)

The electronic device according to (25) or (26), wherein
the signal processing circuit performs light source estimation.
   (28)

The electronic device according to any one of (20) to (27), wherein
the electronic device is an imaging device.
   (28)

The electronic device according to any one of (20) to (27), wherein
the electronic device is a medical device.
   (29)

The electronic device according to any one of (20) to (27), wherein
the electronic device is a smartphone.
   (31)

An imaging element comprising:
pixels; and
pixel groups in which the pixels for receiving light corresponding to three primary colors are arranged in a predetermined arrangement, wherein
the pixels include:
a pixel configured to receive light of a first color in the pixel group that receives the light of the first color among the three primary colors;
a pixel configured to receive the light of a second color in the pixel group that receives the light of the second color among the three primary colors;
a pixel configured to receive the light of a third color in the pixel group that receives the light of the third color among the three primary colors; and
a pixel configured to receive light of a fourth color different from any of the three primary colors in the pixel group that receives the light of any one of the three primary colors, and
a spectrum of the light of the fourth color has a maximum value in a region in which absolute values of negative values in color-matching functions of the first color, the second color, and the third color are larger than in other regions.
   (32)

The imaging element according to (31), wherein
the pixel forms a pixel pair with an adjacent pixel, the imaging element further comprising:
an on-chip lens formed for the pixel pair.
   (33)

The imaging element according to (31) or (32), wherein
the three primary colors are RGB (Red, Green, Blue),
a color-matching function of the fourth color has a maximum value in a wavelength range of 520 nm±10 nm, and
the number of pixels for receiving the light of the fourth color is smaller than the number of pixels for receiving the G light.
   (34)

The imaging element according to (33), wherein
the fourth color is emerald, and
the pixel that receives the light of the fourth color is included in the pixel group that receives the R light.
   (35)

The imaging element according to (34), wherein
in the pixel group that receives the R light, a center of gravity of the pixels that receive the R light is aligned with a center of gravity of the pixels that receive the emerald light.
   (36)

The imaging element according to (33), wherein
the fourth color is emerald, and
the pixel that receives the fourth color light is included in the pixel group that receives the B light.
   (37)

An imaging device comprising the imaging element according to (35) or (36).

(38)

An electronic device comprising the imaging element according to (34).

(39)

The electronic element according to any one of (1) to (38), wherein
the imaging element is formed of a laminated semiconductor.
   (20)

The imaging device according to (39), wherein
the semiconductor is laminated in a form of CoC.
   (41)

The imaging device according to (39), wherein
the semiconductor is laminated in a form of CoW.
   (42)

The imaging device according to (39), wherein
the semiconductor is laminated in a form of WoW.
   (43)

The imaging element according to any one of (1) to (42), wherein
an area of a unit light-receiving region is changed according to the color to be received, an ND filter is provided on a light-receiving surface side of a light-receiving region, or an exposure amount of the light-receiving region is changed.

The aspects of the present disclosure are not limited to the embodiments described above and include various modifications that are conceivable, and effects of the present disclosure are not limited to the above-described content. Constituent elements of the embodiments may be appropriately combined for an application. In other words, various additions, changes, and partial deletions can be performed in a range not departing from the conceptual idea and spirit of the present disclosure derived from content specified in the claims and equivalents thereof.

### REFERENCE SIGNS LIST

1 Electronic device
1a Display region
1b Bezel
2 Imaging element
20 Pixel array
200 Pixel
202 Divided pixel
204 On-chip lens
206 Pixel group
210 Light-receiving unit
212 Storage unit
214 Control unit
216 Signal processor
218 Image processor
3 Component layer
4 Display
5 Cover glass
30 Substrate
32 First substrate
34 Second substrate
300 Pixel region
302 Control circuit
304 Logic circuit

1. An imaging element comprising:
pixels configured to receive light corresponding to three primary colors; and
divided pixels configured to form light-receiving units in the pixels, wherein the divided pixels include:
a divided pixel configured to receive light of a first color in the pixel that receives the light of the first color among the three primary colors;
a divided pixel configured to receive light of a second color in the pixel that receives the light of the second color among the three primary colors;
a divided pixel configured to receive light of a third color in the pixel that receives the light of the third color among the three primary colors; and
a divided pixel configured to receive light of a fourth color different from any of the three primary colors in the pixel that receives the light of any of the three primary colors, and wherein
a spectrum of the light of the fourth color has a maximum value in a region in which absolute values of negative values in color-matching functions of the first color, the second color, and the third color are larger than in other regions.

2. The imaging element according to claim 1, wherein
2×2 or more divided pixels are provided in the pixel.

3. The imaging element according to claim 2, wherein
the three primary colors are RGB (Red, Green, Blue),
a color-matching function of the fourth color has a maximum value in a wavelength range of 520 nm±10 nm, and
the number of divided pixels that receive the light of the fourth color is smaller than the number of divided pixels that receive the G light.

4. The imaging element according to claim 3, wherein
the fourth color is emerald, and
the divided pixel that receives the light of the fourth color is at least one divided pixel among the divided pixels included in the pixel that receives the R light.

5. The imaging element according to claim 4, wherein
the divided pixels that receive emerald light are provided, with a number thereof being in a proportion equal to or less than that of the divided pixels that receive the R light.

6. The imaging element according to claim 5, wherein
at least 2×2 divided pixels are provided in the pixel that receives the R light, and
the divided pixel that receives emerald light is one of the divided pixels in the pixel that receives the R light.

7. The imaging element according to claim 5, wherein
at least 2×2 divided pixels are provided in the pixel that receives the R light, and
the divided pixel that receives the emerald light is provided in an arrangement such that a center of gravity of the divided pixel that receives the emerald light is aligned with a center of gravity of the divided pixel that receives the R light,
among the divided pixels in the pixel that receives the R light.

8. The imaging element according to claim 4, wherein
an output from the divided pixel that receives the R light is corrected using an output from the divided pixel that receives the emerald light.

9. The imaging element according to claim 8, further comprising:
an analog-to-digital conversion circuit configured to acquire an analog signal output from the divided pixel and convert the analog signal into a digital signal, wherein
in the analog-digital conversion circuit, the R light signal and the emerald light signal are counted in opposite directions.

10. The imaging element according to claim 3, wherein
the fourth color is emerald, and
the divided pixel that receives the light of the fourth color is at least one divided pixel among the divided pixels included in the pixel that receives the B light.

11. The imaging element according to claim 10, wherein
an output from the divided pixel that receives the B light is corrected using an output from the divided pixel that receives the emerald light.

12. The imaging element according to claim 1, wherein
the pixel includes an on-chip lens, and
the on-chip lenses provided in the pixel including the divided pixel that receives the light of the fourth color has a shape different from those of the on-chip lenses provided in the other pixels.

13. The imaging element according to claim 4, wherein
the pixel includes an on-chip lens, and
the on-chip lens provided in the pixel including the divided pixels that receive the R and emerald light has a shape different from that of the on-chip lenses provided in the divided pixels that receive the G and B light.

14. The imaging element according to claim 4, wherein
the pixel includes an on-chip lens, and
the on-chip lens is provided so as to cover all the divided pixels in the pixel including the divided pixels that receive the R and emerald light and are arranged in a vertically and horizontally symmetrical arrangement.

15. An imaging device comprising the imaging element according to claim 1.

16. An electronic device comprising:
pixels configured to receive light corresponding to three primary colors of RGB;
2×2 or more divided pixels configured to form light-receiving units in the pixels; and
a display having a display surface on a light-receiving surface side of the pixels,
and having the pixels embedded therein, wherein
the divided pixels include:
a divided pixel configured to receive light of a first color among the three primary colors;
a divided pixel configured to receive light of a second color among the three primary colors;
a divided pixel configured to receive light of a third color among the three primary colors; and
a divided pixel configured to receive light of an emerald color different from any of the three primary colors, and
a spectrum of the light of the emerald color has a maximum value in a wavelength range of 520 nm±10 nm, and the number of divided pixels that receive the emerald light is smaller than the number of divided pixels that receive the G light.

17. The electronic device according to claim 16, wherein
the display is made of a material containing a material that absorbs light in a wavelength region of 450 nm or less.

18. The electronic device according to claim 16, wherein
an output from the divided pixel that receives the R light is corrected based on an output from the divided pixel that receives the emerald light.

19. The electronic device according to claim 16, wherein
an output from the divided pixel that receives the B light is corrected based on an output from the divided pixel that receives the emerald light.

20. The electronic device according to claim 16, further comprising:
an analog to-digital conversion circuit configured to convert an analog signal output from the divided pixels into a digital signal; and
a signal processing circuit configured to perform signal processing on an output of the analog-to-digital conversion circuit, wherein
the signal processing circuit improves light sensing accuracy, based on the digital signal.
